(19) United States
(12) Patent Application Publication
(10) Pub. No.: US 2026/0234777 A1
(43) Pub. Date: Aug. 13, 2026

(54) COLD-ROLLED STEEL SHEET AND STEEL MEMBER

(71) Applicant: NIPPON STEEL CORPORATION, Tokyo (JP)

(72) Inventor: Yuya SUZUKI, Tokyo (JP)

(73) Assignee: NIPPON STEEL CORPORATION, Tokyo (JP)

(21) Appl. No.: 19/160,705

(22) PCT Filed: Apr. 5, 2024
(86) PCT No.: PCT/JP2024/014114

§ 371 Date: Aug. 28, 2025

(30) Foreign Application Priority Data
Apr. 5, 2023 (JP) 2023-061317

(51) Int. Cl. C22C 38/60; B32B 15/01; C21D 6/00; C21D 8/04; C21D 9/48; C22C 38/00; C22C 38/02; C22C 38/04; C22C 38/06; C22C 38/08; C22C 38/10; C22C 38/12; C22C 38/14; C22C 38/16; C22C 38/20; C22C 38/22; C22C 38/24; C22C 38/26; C22C 38/28; C22C 38/32; C22C 38/38; C22C 38/42; C22C 38/44; C22C 38/46; C22C 38/48; C22C 38/50; C22C 38/52; C22C 38/54; C22C 38/58

(52) U.S. Cl. CPC C22C 38/60; B32B 15/013; C21D 6/001; C21D 6/002; C21D 6/004; C21D 6/005; C21D 6/007; C21D 6/008; C21D 8/0426; C21D 8/0436; C21D 8/0463; C21D 8/0478; C21D 9/48; C22C 38/001; C22C 38/002; C22C 38/005; C22C 38/008; C22C 38/02; C22C 38/04; C22C 38/06; C22C 38/08; C22C 38/10; C22C 38/105; C22C 38/12; C22C 38/14; C22C 38/16; C22C 38/20; C22C 38/22; C22C 38/24; C22C 38/26; C22C 38/28; C22C 38/32; C22C 38/38; C22C 38/42; C22C 38/44; C22C 38/46; C22C 38/48; C22C 38/50; C22C 38/52; C22C 38/54; C22C 38/58; B32B 2250/02; B32B 2311/20; B32B 2311/30; C21D 2211/008

(57) ABSTRACT

This cold-rolled steel sheet has a predetermined chemical composition, in which, when a sheet thickness in units of mm is denoted by t, and a range from a t/8 position to a 3t/8 position in a sheet thickness direction from a surface of the cold-rolled steel sheet is denoted by a t/4 position, at the t/4 position, a microstructure contains, by volume percentage, martensite: 95% or more, in which a volume percentage of tempered martensite is 95% or less, a prior austenite grain size is 7.0 μm or less, and a grain boundary segregation degree of Mn is 2.0 or less.

### TECHNICAL FIELD

The present invention relates to a cold-rolled steel sheet and a steel member.

Priority is claimed on Japanese Patent Application No. 2023-061317, filed Apr. 5, 2023, the content of which is incorporated herein by reference.

### BACKGROUND ART

Today, as industrial technology fields are highly divided, materials used in each technology field require special and advanced performance. In particular, with regard to steel sheets for a vehicle, in order to reduce a weight of a vehicle body and improve fuel efficiency in consideration of the global environment, there is a significantly increasing demand for cold rolled high tensile strength steel sheets having a small sheet thickness and high formability. Among the steel sheets for a vehicle, particularly for cold-rolled steel sheets used for vehicle body frame components, high strength is required, and furthermore, high formability for wide applications is required. Examples of properties required for a steel sheet for a vehicle include a tensile strength (TS) of 1,310 MPa or more and excellent bendability.

Furthermore, in recent years, in order to sufficiently secure corrosion resistance of a vehicle body and components, high strength hot-dip galvanized steel sheets and high strength hot-dip galvannealed steel sheets in which a galvanized layer is provided on a surface of a steel sheet have also been applied.

For example, Patent Document 1 discloses a hot-dip galvanized steel sheet and a hot-dip galvannealed steel sheet having 980 MPa or more and being excellent in plating properties, formability in terms of a balance between strength and ductility, bendability, and hole expansibility, and delayed fracture resistance, and a method of manufacturing the same.

However, there are problems in high strength hot-dip galvanized steel sheets and high strength hot-dip galvannealed steel sheets for vehicle components. That is, resistance spot welding is mainly used in processes such as assembly of a vehicle body and attachment of components. The resistance spot welding is a type of resistance welding in which overlapping base metals are clamped between tips of electrodes of which the tips are appropriately shaped, and a current and a weld force are concentrated on a relatively small portion to locally heat the portion. However, when galvanized steel sheets (hot-dip galvanized steel sheets, electrogalvanized steel sheets, or hot-dip galvannealed steel sheets) are resistance spot-welded for the assembly of the vehicle body and/or the components, cracking called liquid metal embrittlement (LME) cracking may occur in the spot-welded part. LME cracking is cracking that occurs when zinc in a galvanized layer melts due to heat generated during resistance spot welding, molten zinc infiltrates into grain boundaries of a steel sheet structure in a welded part, and tensile stress acts thereon in the state. Requirements for the occurrence of cracking are the contact between molten zinc and solid steel sheets during welding and the presence of a tensile stress (strain) acting on the site. Susceptibility to LME cracking tends to increase with high-strengthening of the steel sheet.

In Patent Document 1, a steel sheet having a tensile strength of 1,310 MPa or more and excellent bendability is not disclosed, and measures against LME cracking are not considered.

Regarding the above problems, a technology has been proposed to improve LME resistance during spot welding of a galvanized steel sheet.

For example, Patent Document 2 discloses a steel sheet in which, in a cross-sectional structure cut in a width direction perpendicular to a rolling direction, a block diameter in a first depth region of 1 to 10 μm from a surface, a block diameter in a second depth region of 10 to 60 μm from the surface, and a block diameter in a third depth region of 60 μm to a ¼ sheet thickness from the surface are each specified.

Patent Document 2 shows that by forming a three-layer structure in which the block diameters are gradient-controlled from a sheet thickness surface layer toward a sheet thickness center layer, a soft layer (second layer) with a large block diameter bears strain in a case of being subjected to deformation even during spot welding, and an excessive increase in strain in an outermost layer (first layer) can be suppressed, so that the occurrence of spot weld LME cracking can be suppressed.

However, in Patent Document 2, bendability is not taken into consideration, and it is considered that there is room for improvement in bendability.

### CITATION LIST

### Patent Documents

Patent Document 1: PCT International Publication No. WO2016/111275

Patent Document 2: PCT International Publication No. WO2021/251276

### SUMMARY OF INVENTION

### Technical Problem

As described above, in the related art, a steel sheet having a high tensile strength, excellent bendability, and superior LME resistance has not been disclosed. Therefore, an object of the present invention is to provide a cold-rolled steel sheet having a high tensile strength, excellent bendability, and superior LME resistance, and a steel member obtained by processing the cold-rolled steel sheet.

Here, the cold-rolled steel sheet includes a plated steel sheet in which a plating layer is formed on a surface, and the steel member includes a steel member such as a surface-treated steel material in which a plating layer is formed on a surface.

### Solution to Problem

The present inventors have studied a method for increasing tensile strength, bendability, and LME resistance of a cold-rolled steel sheet. As a result, the following findings were obtained.

Within a microstructure, the tensile strength can be increased by increasing a volume percentage of martensite.

In a chemical composition of the cold-rolled steel sheet, the LME resistance is improved by increasing an Al content. On the other hand, increasing the Al content raises an Ac3 point, and in a case where a heat treatment performed in the manufacture of a general cold-rolled steel sheet is applied, prior γ grains become large, resulting in a decrease in the bendability.

In order to reduce a prior γ grain size, repeated transformation between a γ single phase and a shear type transformation structure (bainite and martensite) is effective.

The bendability is further improved by suppressing Mn segregation to prior γ grain boundaries.

The present invention has been made in view of the above findings. The gist of the present invention is as follows.

[1] A cold-rolled steel sheet according to an aspect of the present invention includes, as a chemical composition, by mass %: C: 0.180% or more and 0.400% or less; Si: 0.050% or more and 1.000% or less; Mn: 2.00% or more and 4.00% or less; Al: 0.10% or more and 2.00% or less; Ti: 0.010% or more and 0.200% or less; B: 0.0010% or more and 0.0100% or less; N: 0.0010% or more and 0.0100% or less; P: 0% or more and 0.0400% or less; S: 0% or more and 0.0100% or less; O: 0% or more and 0.0060% or less; Cr: 0% or more and 0.50% or less; Ni: 0% or more and 1.00% or less; Cu: 0% or more and 1.00% or less; Mo: 0% or more and 0.500% or less; Nb: 0% or more and 0.200% or less; V: 0% or more and 0.500% or less; W: 0% or more and 0.100% or less; Ta: 0% or more and 0.100% or less; Sn: 0% or more and 0.050% or less; Co: 0% or more and 0.500% or less; Sb: 0% or more and 0.050% or less; As: 0% or more and 0.050% or less; Mg: 0% or more and 0.050% or less; Ca: 0% or more and 0.040% or less; REM: 0% or more and 0.050% or less; Bi: 0% or more and 0.050% or less; Zr: 0% or more and 0.050% or less; Sr: 0% or more and 0.050% or less; and a remainder including Fe and impurities, in which, when a sheet thickness in units of mm is denoted by t, and a range from a t/8 position to a 3t/8 position in a sheet thickness direction from a surface of the cold-rolled steel sheet is denoted by a t/4 position, at the t/4 position, a microstructure contains, by volume percentage, martensite: 95% or more, in which a volume percentage of tempered martensite is 95% or less, a prior austenite grain size is 7.0 μm or less, and a grain boundary segregation degree of Mn is 2.0 or less.

[2] In the cold-rolled steel sheet according to [1], the cold-rolled steel sheet may have a hot-dip galvanized layer on the surface.

[3] In the cold-rolled steel sheet according to [2], the hot-dip galvanized layer may be a hot-dip galvannealed layer.

[4] A steel member according to another aspect of the present invention is a member including: a processed portion; and a non-processed portion, in which at least the non-processed portion contains, as a chemical composition, by mass %, C: 0.180% or more and 0.400% or less, Si: 0.050% or more and 1.000% or less, Mn: 2.00% or more and 4.00% or less, Al: 0.10% or more and 2.00% or less, Ti: 0.010% or more and 0.200% or less, B: 0.0010% or more and 0.0100% or less, N: 0.0010% or more and 0.0100% or less, P: 0% or more and 0.0400% or less, S: 0% or more and 0.0100% or less, O: 0% or more and 0.0060% or less, Cr: 0% or more and 0.50% or less, Ni: 0% or more and 1.00% or less, Cu: 0% or more and 1.00% or less, Mo: 0% or more and 0.500% or less, Nb: 0% or more and 0.200% or less, V: 0% or more and 0.500% or less, W: 0% or more and 0.100% or less, Ta: 0% or more and 0.100% or less, Sn: 0% or more and 0.050% or less, Co: 0% or more and 0.500% or less, Sb: 0% or more and 0.050% or less, As: 0% or more and 0.050% or less, Mg: 0% or more and 0.050% or less, Ca: 0% or more and 0.040% or less, REM: 0% or more and 0.050% or less, Bi: 0% or more and 0.050% or less, Zr: 0% or more and 0.050% or less, Sr: 0% or more and 0.050% or less, and a remainder including Fe and impurities, when a thickness in units of mm is denoted by t, and a range from a t/8 position to a 3t/8 position in a thickness direction from a surface of the steel member is denoted by a t/4 position, at the t/4 position, a microstructure contains, by volume percentage, martensite: 95% or more, in which a volume percentage of tempered martensite is 95% or less, a prior austenite grain size is 7.0 μm or less, and a grain boundary segregation degree of Mn is 2.0 or less.

[5] In the steel member according to [4], the steel member may have a hot-dip galvanized layer on the surface.

[6] In the steel member according to [5], the hot-dip galvanized layer may be a hot-dip galvannealed layer.

### Advantageous Effects of Invention

According to the above aspects of the present invention, it is possible to provide a cold-rolled steel sheet having a high tensile strength, excellent bendability, and superior LME resistance, and a steel member obtained by processing the cold-rolled steel sheet.

### BRIEF DESCRIPTION OF DRAWINGS

FIG. 1A A view showing an aspect in which two steel sheets are subjected to spot welding.

FIG. 1B A view showing an aspect of current control when the two steel sheets are spot-welded.

FIG. 2 A view showing an aspect of occurrence of cracks after spot welding.

FIG. 3 A view showing a cross section of a steel member created in an example.

### DESCRIPTION OF EMBODIMENTS

A cold-rolled steel sheet according to an embodiment of the present invention (a steel sheet according to the present embodiment), and a steel member according to an embodiment of the present invention (a steel member according to the present embodiment) will be described.

In the present embodiment, a sheet thickness of the cold-rolled steel sheet is denoted by t in units of mm, and a range from a t/8 position to a 3t/8 position in a sheet thickness direction from a surface of the cold-rolled steel sheet is denoted by a t/4 position in the description.

In addition, similarly, a thickness (in a case of a steel sheet, a sheet thickness of the steel sheet) of a non-processed portion of the steel member in units of mm is denoted by t, and a range from a t/8 position to a 3t/8 position in a thickness direction from a surface of the steel member is denoted by a t/4 position in the description.

### <Cold-Rolled Steel Sheet>

The steel sheet according to the present embodiment has a predetermined chemical composition, in which, at the t/4 position, a microstructure contains, by volume percentage, martensite: 95% or more, in which a volume percentage of tempered martensite is 95% or less, a prior austenite grain size is 7 μm or less, and a grain boundary segregation degree of Mn is 2.0 or less.

Each of the above will be described in detail below.

### [Chemical Composition]

The reasons for limiting the chemical composition of the steel sheet according to the present embodiment will be described. “%” regarding the amount of each element constituting the chemical composition means “mass %” unless otherwise specified.

### C: 0.180% or More and 0.400% or Less

C (carbon) is an essential element for securing strength of the steel sheet. By setting a C content to 0.180% or more, desired high strength can be obtained. The C content is preferably 0.200% or more, and more preferably 0.220% or more. On the other hand, in order to secure formability and weldability, the C content is set to 0.400% or less. The C content is preferably 0.380% or less, and more preferably 0.360% or less.

### Si: 0.050% or More and 1.000% or Less

Silicon (Si) is an element that contributes to an improvement in the strength of the steel sheet by suppressing temper softening of martensite, in addition to solid solution strengthening. In order to obtain this effect, a Si content is set to 0.050% or more. On the other hand, in order to secure the weldability of the steel sheet, the Si content is set to 1.000% or less. The Si content is preferably 0.700% or less and more preferably 0.500% or less.

### Mn: 2.00% or More and 4.00% or Less

Mn (manganese) is a strong austenite stabilizing element, and is an effective element for high-strengthening of the steel sheet. In order to obtain this effect, a Mn content is set to 2.00% or more. The Mn content is preferably 2.20% or more, and more preferably 2.40% or more.

On the other hand, a high Mn content leads to a decrease in the weldability and low temperature toughness. Therefore, the Mn content is set to 4.00% or less. The Mn content is preferably 3.60% or less, and more preferably 3.20% or less.

### Al: 0.10% or More and 2.00% or Less

Al (aluminum) is an element used for deoxidation of steel, and like Si, is an effective element for improving the strength of the steel sheet by suppressing the generation of iron carbides and suppressing the temper softening of martensite. In addition, Al is an element that contributes to an improvement in LME resistance. In order to obtain the above effect, an Al content is set to 0.10% or more. The Al content is preferably more than 0.10%, more preferably 0.15% or more, and even more preferably 0.20% or more.

On the other hand, even when Al is excessively contained, the effect is saturated and costs increase unnecessarily. In addition, there is a possibility that coarse carbonitrides are precipitated during casting, causing embrittlement of a slab and cracking. Therefore, the Al content is set to 2.00% or less. The Al content is preferably 1.20% or less, and more preferably 0.80% or less. The Al content mentioned here is an acid-soluble Al content (sol. Al content).

### Ti: 0.010% or More and 0.200% or Less

Ti (titanium) is an effective element for securing solute B that contributes to an improvement in hardenability by fixing N in a form of TiN. In order to obtain this effect, a Ti content is set to 0.010% or more.

On the other hand, when the Ti content exceeds 0.200%, there is a concern that coarse carbonitrides are precipitated and formability decreases. Therefore, the Ti content is set to 0.200% or less. The Ti content is preferably 0.180% or less, and more preferably 0.160% or less.

### B: 0.0010% or More and 0.0100% or Less

B (boron) is an element that is segregated to austenite grain boundaries during welding, strengthens grain boundaries, and contributes to the improvement in the LME resistance. In addition, B is an element that enhances the hardenability of steel and contributes to high-strengthening of the steel sheet.

In order to obtain the above effect, a B content is set to 0.0010% or more. The B content is preferably 0.0015% or more, and more preferably 0.0020% or more.

On the other hand, when the B content exceeds 0.0100%, carbides and nitrides are generated, the above-described effects are saturated, and hot formability decreases. Therefore, the B content is set to 0.0100% or less. The B content is preferably 0.0080% or less, more preferably 0.0050% or less, and even more preferably 0.0030% or less.

### N: 0.0010% or More and 0.0100% or Less

N (nitrogen) is an element that is bonded to Al to precipitate as AlN and contributes to refinement of a structure. In order to obtain this effect, a N content is set to 0.0010% or more. The N content is preferably 0.0020% or more.

On the other hand, when the N content exceeds 0.0100%, coarse nitrides are formed in steel, and bendability and hole expansibility deteriorate. Therefore, the N content is set to 0.0100% or less. The N content is preferably 0.0080% or less, and more preferably 0.0060% or less.

### P: 0% or More and 0.0400% or Less

P (phosphorus) is a solid solution strengthening element, and is an effective element for the high-strengthening of the steel sheet, but excessive inclusion thereof deteriorates the weldability and toughness. Therefore, a P content is set to 0.0400% or less. The P content is preferably 0.0350% or less, 0.0300% or less, or 0.0200% or less. The P content may be 0%, but extremely reducing the P content increases a dephosphorization cost. Therefore, the P content may be set to 0.0010% or more from the viewpoint of economic efficiency.

### S: 0% or More and 0.0100% or Less

S (sulfur) is an element contained as an impurity, and is an element which forms MnS in steel and deteriorates the toughness and hole expansibility. Therefore, a S content is set to 0.0100% or less as a range in which the deterioration of the toughness and hole expansibility is not significant. The S content is preferably 0.0050% or less, 0.0040% or less, or 0.0030% or less. The S content may be 0%, but extremely reducing the S content increases a desulfurization cost. Therefore, the S content may be set to 0.0001% or more, or 0.0010% or more from the viewpoint of economic efficiency.

### O: 0% or More and 0.0060% or Less

O (oxygen) is an element contained as an impurity, and is an element which forms coarse oxides in steel and deteriorates the bendability and hole expansibility when an O content exceeds 0.0060%. Therefore, the O content is set to 0.0060% or less. The O content is preferably 0.0050% or less, and more preferably 0.0040% or less. The O content may be 0%, but the O content may be set to 0.0001% or more from the viewpoint of manufacturing costs.

The steel sheet according to the present embodiment contains, as a basic chemical composition, the above-described elements (basic elements) and the remainder including Fe and impurities. Here, the “impurities” are components that are mixed due to various factors of raw materials such as ore and scrap and a manufacturing process when the steel sheet is industrially manufactured, and are allowed to be contained within a range in which the effects of the steel sheet according to the present embodiment are not clearly adversely affected.

The steel sheet according to the present embodiment may contain the following elements (optional elements) instead of a part of Fe as necessary. Since these elements do not necessarily have to be contained, lower limits thereof are 0%. In addition, the following elements may be mixed from scrap or the like in the raw materials, but may be intentionally contained in the steel sheet or may be unintentionally contained in the steel sheet in amounts equal to or less than the upper limits described below. For example, there are cases where the following elements are contained in the steel sheet by being contained in scrap or the like in the raw materials of the steel sheet.

### Cr: 0% or More and 0.50% or Less

### Ni: 0% or More and 1.00% or Less

### Cu: 0% or More and 1.00% or Less

Cr (chromium), Ni (nickel), and Cu (copper) are all elements that contribute to an improvement in strength. Therefore, one or more selected from these elements may be contained as necessary. In a case where the above effect is to be obtained, the amount of one or more selected from Cr, Ni, and Cu is preferably 0.01% or more, and more preferably 0.10% or more.

On the other hand, there is a concern that a Cr content exceeding 0.50%, a Ni content exceeding 1.00%, or a Cu content exceeding 1.00% causes a decrease in pickling properties, weldability, and hot formability. Therefore, the Cr content is set to 0.50% or less, the Ni content is set to 1.00% or less, and the Cu content is set to 1.00% or less. The Cr content may be 0.40% or less, 0.30% or less, or 0.10% or less. The Ni content may be 0.80% or less, 0.60% or less, or 0.20% or less. The Cu content may be 0.80% or less, 0.60% or less, or 0.20% or less.

### Mo: 0% or More and 0.500% or Less

Mo (molybdenum) is, like Mn, an element that increases the hardenability of steel and contributes to the improvement in strength. Therefore, Mo may be contained as necessary. In a case where the above effect is to be obtained, a Mo content is preferably 0.010% or more, and more preferably 0.100% or more.

On the other hand, when the Mo content exceeds 0.500%, the hot formability decreases, and there is a concern that productivity decreases. Therefore, the Mo content is set to 0.500% or less. The Mo content is preferably 0.400% or less, more preferably 0.300% or less, and even more preferably 0.100% or less.

### Nb: 0% or More and 0.200% or Less

### V: 0% or More and 0.500% or Less

Both Nb (niobium) and V (vanadium) are elements that contribute to the improvement in the strength of the steel sheet by precipitation hardening, grain refinement strengthening by suppressing crystal grain growth, and dislocation strengthening by suppressing recrystallization. Therefore, one or more selected from these elements may be contained as necessary. In a case where the above effect is to be obtained, it is preferable that one or two of 0.001% or more of Nb and 0.001% or more of V are contained in the steel sheet.

On the other hand, there is a concern that a Nb content exceeding 0.200% or a V content exceeding 0.500% causes the precipitation of coarse carbonitrides and a decrease in the formability. Therefore, the Nb content is set to 0.200% or less, and the V content is set to 0.500% or less. The Nb content is preferably 0.180% or less, more preferably 0.150% or less, and even more preferably 0.100% or less. The V content is preferably 0.400% or less, more preferably 0.300% or less, and even more preferably 0.100% or less.

### W: 0% or More and 0.100% or Less

### Ta: 0% or More and 0.100% or Less

### Sn: 0% or More and 0.050% or Less

### Co: 0% or More and 0.500% or Less

### As: 0% or More and 0.050% or Less

W (tungsten), Ta (tantalum), Sn (tin), Co (cobalt), and As (arsenic) are elements that contribute to the improvement in the strength of the steel sheet by precipitation hardening and suppression of coarsening of crystal grains. Therefore, these elements may be contained. In a case where the effect is to be obtained, it is preferable to contain one or two or more of these elements, and set a W content to 0.001% or more, a Ta content to 0.001% or more, a Sn content to 0.001% or more, a Co content to 0.001% or more, and an As content to 0.001% or more.

Meanwhile, when these elements are contained in a large amount, there is a concern that various properties of the steel sheet are impaired. Therefore, the W content is set to 0.100% or less, the Ta content is set to 0.100% or less, the Sn content is set to 0.050% or less, the Co content is set to 0.500 or less, and the As content is set to 0.050% or less. The W content is preferably 0.080% or less, more preferably 0.050% or less, and even more preferably 0.030% or less. The Ta content is preferably 0.080% or less, more preferably 0.050% or less, and even more preferably 0.030% or less. The Sn content is preferably 0.040% or less, more preferably 0.030% or less, and even more preferably 0.010% or less. The Co content is preferably 0.400% or less, more preferably 0.300% or less, and even more preferably 0.100% or less. The As content is preferably 0.040% or less, more preferably 0.030% or less, and even more preferably 0.010% or less.

### Sb: 0% or More and 0.050% or Less

### Mg: 0% or More and 0.050% or Less

### Ca: 0% or More and 0.040% or Less

### REM: 0% or More and 0.050% or Less

### Zr: 0% or More and 0.050% or Less

### Bi: 0% or More and 0.050% or Less

Sb (antimony), Mg (magnesium), Ca (calcium), REM (rare earth metal), Zr (zirconium), Bi (bismuth), and Sr (strontium) are all elements that contribute to the improvement in formability. Therefore, one or more selected from these elements may be contained as necessary. In a case where the above effect is to be obtained, it is preferable to contain one or two or more selected from Sb, Mg, Ca, REM, Zr, Bi, and Sr and set the amount of each contained element to 0.001% or more. The amount of each element is more preferably 0.002% or more.

On the other hand, there is a concern that a Sb, Mg, REM, Zr, Bi, or Sr content exceeding 0.050% or a Ca content exceeding 0.040% causes the decrease in the pickling properties, weldability, and hot formability. Therefore, the Sb, Mg, REM, Zr, Bi, and Sr contents are all set to 0.050% or less, and the Ca content is set to 0.040% or less. Each of the Sb, Mg, Ca, REM, Zr, Bi, and Sr contents is preferably 0.035% or less, 0.030% or less, or 0.010% or less. In the present embodiment, REM means rare earth elements and is a generic term for a total of 17 elements including Sc, Y, and lanthanoids, and the REM content is a total amount of these elements.

As described above, a base steel sheet of the steel sheet according to the present embodiment contains, as a chemical composition, basic elements and the remainder including Fe and impurities, or contains basic elements and further contains one or more optional elements (elements other than impurities of which lower limits in amounts in the above description are 0%) and the remainder including Fe and impurities.

The chemical composition of the base steel sheet of the steel sheet according to the present embodiment may be measured by a general method. For example, the chemical composition may be measured using inductively coupled plasma-atomic emission spectrometry (ICP-AES) for chips according to JIS G 1201:2014. In this case, the chemical composition is an average content throughout an entire sheet thickness. For the elements which are difficult to measure by ICP-AES, C and S may be measured using a combustion-infrared absorption method, N may be measured using an inert gas fusion-thermal conductivity method, and O may be measured using an inert gas fusion-non-dispersive infrared absorption method.

An analysis sample is collected so as to obtain an average chemical composition throughout the overall sheet thickness of the base steel sheet, as described in JIS G 0417:1999. Specifically, the analysis sample is collected from the t/4 position while avoiding end portions of the base steel sheet in a width direction.

### [Microstructure at t/4 Position]

### (Martensite: 95 Volume % or More)

### (Tempered Martensite: 95 Volume % or Less)

In the steel sheet according to the present embodiment, a volume percentage of martensite is set to 95% or more to secure a tensile strength of 1,310 MPa or more. When the volume percentage of martensite is less than 95%, a sufficient tensile strength cannot be secured. The volume percentage of martensite may be 100%.

In the present embodiment, martensite includes fresh martensite and tempered martensite (including self-tempered martensite). However, when a volume percentage of tempered martensite is more than 95%, a sufficient tensile strength cannot be obtained. Therefore, the volume percentage of tempered martensite is set to 95% or less. That is, the volume percentage of tempered martensite is 95% or less, and a total volume percentage of tempered martensite and fresh martensite is 95% or more. The total volume percentage of tempered martensite and fresh martensite may be 100%.

Fresh martensite is effective in terms of contributing to the high-strengthening. Therefore, in a case where the tensile strength is desired to be increased, it is preferable to increase an area ratio of fresh martensite. For example, fresh martensite occupies 85% or more, 90% or more, or 95% or more. On the other hand, fresh martensite has a brittle structure and is inferior in formability. Therefore, from the viewpoint of formability, tempered martensite is preferable. Specifically, in a case where the formability is important, the volume percentage of tempered martensite is preferably 80% or more.

The remainder of the microstructure may be one or more selected from ferrite, pearlite, bainite, and residual austenite.

A volume percentage of each structure (each phase) at the t/4 position is obtained by the following procedure.

That is, for the volume percentages of ferrite, pearlite, bainite, fresh martensite, and tempered martensite, a test piece is collected from a certain position in a rolling direction of the steel sheet at a center position in the width direction, a longitudinal section (that is, a cross section parallel to the rolling direction and parallel to the thickness direction) parallel to the rolling direction is polished, and a microstructure that is revealed by nital etching at the t/4 position is observed using SEM. In the SEM observation, five visual fields of 30 μm in the sheet thickness direction and 50 μm in the rolling direction are observed at the t/4 position at a magnification of 3,000-fold. An area ratio of each structure is measured from the observed image, and an average value thereof is calculated. An area ratio of the longitudinal section parallel to the rolling direction, in which no microstructural change occurs in a direction (steel sheet width direction) perpendicular to the rolling direction, is considered to be equal to a volume percentage, and the area ratio obtained by the microstructural observation is taken as the volume percentage.

In the measurement of the area ratio of each structure, a region with no substructure revealed and a low luminance is defined as ferrite. In addition, a region that is a layered structure of ferrite and cementite is defined as pearlite. In addition, a region with no substructure revealed and a high luminance is defined as fresh martensite or residual austenite. In addition, a region in which a substructure is revealed is defined as tempered martensite or bainite.

Bainite and tempered martensite can be distinguished from each other by further carefully observing intragranular carbides.

Specifically, tempered martensite includes martensite laths and cementite generated within the laths. Here, since there are two or more kinds of crystal orientation relationships between martensite laths and cementite, cementite included in the tempered martensite has a plurality of variants. On the other hand, bainite is classified into upper bainite and lower bainite. Upper bainite includes lath-shaped bainitic ferrite and cementite generated at the interface between the laths and is thus easily distinguished from tempered martensite. Lower bainite includes lath-shaped bainitic ferrite and cementite generated within the laths. Here, there is one kind of crystal orientation relationship between bainitic ferrite and cementite unlike tempered martensite, and cementite included in lower bainite has the same variant. Therefore, lower bainite and tempered martensite are distinguished from each other on the basis of the variants of cementite.

On the other hand, fresh martensite and residual austenite are not clearly distinguished from each other by the SEM observation. Therefore, a volume percentage of martensite is calculated by subtracting the volume percentage of residual austenite calculated by a method described later from a volume percentage of a structure determined to be martensite or residual austenite.

The volume percentage of residual austenite is obtained by collecting a test piece from a certain position in the rolling direction of the steel sheet at a center position in the width direction, chemically polishing a rolled surface from the surface of the steel sheet to the ¼ position of the sheet thickness, and quantifying integrated intensities of (200) and (210) planes of ferrite and (200), (220), and (311) planes of austenite by MoKα radiation.

### (Prior Austenite Grain Size (Prior γ Grain Size): 7.0 μm or Less)

In the steel sheet according to the present embodiment, the prior austenite grain size is 7.0 μm or less in the microstructure at the t/4 position. By refining the prior austenite grain size, the bendability is improved, and the LME resistance is improved. When the prior austenite grain size is more than 7.0 μm, bendability and LME resistance become insufficient. A lower limit of the prior austenite grain size is not limited. However, excessive refinement of the prior austenite grain size may require special equipment and thus become economically disadvantageous. Therefore, the prior austenite grain size may be 4.0 μm or more.

Here, the prior austenite grain size is a circle equivalent diameter of a range surrounded by prior austenite grain boundaries when grain boundaries appearing on a cleavage surface are regarded as prior austenite grain boundaries.

### (Mn Grain Boundary Segregation Degree: 2.0 or Less)

In addition, in the steel sheet according to the present embodiment, in the microstructure at the t/4 position, the grain boundary segregation degree of Mn, which is a ratio of the Mn content at the grain boundaries to an average Mn content of a base metal part (the Mn content described in the chemical composition described above), is 2.0 or less.

Mn is an element that is likely to segregate to grain boundaries. However, in the steel sheet according to the present embodiment, the bendability is improved by reducing the segregation degree of Mn to the grain boundaries (so that the Mn content at the grain boundaries is 2.0 times or less the average Mn content). When the grain boundary segregation degree of Mn is more than 2.0, the bendability deteriorates. A lower limit of the grain boundary segregation degree of Mn is not limited. However, when the grain boundary segregation degree of Mn is set to less than 1.3, the productivity decreases. Therefore, from the viewpoint of economic rationality, the Mn segregation degree may be 1.3 or more.

The prior austenite grain size and the grain boundary segregation degree of Mn at the t/4 position are obtained by the following methods.

A test piece is collected from any position in the rolling direction of the steel sheet at a center position in the width direction (a position 50 mm or more away from an end portion in a case where the center position is unclear), and a notch is further introduced at a center portion of the test piece in the rolling direction. The test piece with the notch is cooled to a temperature close to a liquid nitrogen temperature, and the test piece is subjected to impact fracture in a vacuum chamber to obtain a cleavage surface.

In the cleavage surface at the t/4 position, grain boundaries appearing on the cleavage surface observed by SEM are regarded as prior austenite grain boundaries, and a circle equivalent diameter of a range surrounded by the prior austenite grain boundaries is regarded as the prior austenite grain size.

In addition, in the cleavage surface at the t/4 position, Mn concentrations at five different grain boundaries are measured by Auger electron spectroscopy. During the measurement, an acceleration voltage is set to 10 kV, and a current value is set to 10 nA. An average value of the Mn concentrations at the five grain boundaries obtained as a result of the measurement is regarded as the Mn concentration at the prior austenite grain boundary. A value obtained by dividing the Mn concentration by the average Mn content of the steel sheet measured by the above-described ICP-AES is taken as the grain boundary segregation degree. In a case where the prior austenite grain boundaries are not revealed in the measurement, the prior austenite grain boundaries can be revealed by performing the following hydrogen charging in advance. That is, the test piece with the notch is subjected to cathodic hydrogen charging in a solution having a concentration of ammonium thiocyanate of 20 g/L or more at a current density of 0.1 mA/cm² or more for 24 hours or longer. After the cathodic hydrogen charging, electrogalvanizing may be performed for the purpose of preventing hydrogen desorption. Thereafter, impact fracture is performed in the vacuum chamber. The prior austenite grain boundaries are more likely to be revealed by increasing the concentration of ammonium thiocyanate or by increasing the current density.

### [Properties]

### (Tensile Strength)

In the steel sheet according to the present embodiment, an object is to achieve a tensile strength (TS) of 1,310 MPa or more as a strength that contributes to a reduction in weight of a vehicle body of a vehicle. An upper limit of the tensile strength is not limited. However, when the tensile strength is high, there is a concern that the formability decreases. Therefore, the tensile strength may be set to 1,600 MPa or less.

The tensile strength (TS) is obtained by collecting a JIS No. 5 tensile test piece from the steel sheet in a direction perpendicular to the rolling direction and performing a tensile test according to JIS Z 2241:2011.

In a case where the JIS No. 5 tensile test piece cannot be collected, the tensile strength may be estimated from Vickers hardness. Specifically, a hardness test is conducted at the t/4 position of the cross section with a load of 1 kgf in accordance with JIS Z 2244-1:2020. A value obtained by multiplying the obtained hardness (Hv) by 3.3 is defined as the tensile strength TS. In terms of the Vickers hardness, 400 Hv or more is to be achieved.

### (Bending)

In the steel sheet according to the present embodiment, the chemical composition and the microstructure are controlled as described above, so that the steel sheet has excellent bendability and LME resistance.

As the bendability, for example, it is preferable that a product of a maximum bending angle evaluated by a bending test according to the VDA standard and the tensile strength TS is 130,000 (MPa degree) or more.

In addition, as the LME resistance, it is preferable that LME cracking does not occur when spot welding is performed in a case where the steel sheet has a galvanized layer or an opposite material is a galvanized steel sheet.

### [Sheet Thickness]

The sheet thickness of the steel sheet according to the present embodiment is not limited, but is preferably 1.0 to 3.0 mm from the viewpoint of achieving both the reduction in the weight of the vehicle body and the improvement of collision safety.

### [Plating Layer]

The steel sheet according to the present embodiment may have a galvanized layer. Corrosion resistance is improved by providing the galvanized layer. When there is a concern about holes due to corrosion in a steel sheet for a vehicle, there are cases where the steel sheet cannot be thinned to a certain sheet thickness or less even if the high-strengthening is achieved. One of the purposes of the high-strengthening of the steel sheet is to reduce the weight by thinning. Therefore, even if a high strength steel sheet is developed, an application range of a steel sheet with low corrosion resistance is limited. As a method for solving these problems, a highly corrosion-resistant galvanized layer may be formed on the surface of the steel sheet.

The galvanized layer may be a hot-dip galvanized layer or a hot-dip galvannealed layer that has undergone alloying. The hot-dip galvanized layer is preferable from the viewpoint of costs, and the hot-dip galvannealed layer is preferable from the viewpoint of obtaining excellent weldability and coatability since Fe is incorporated into the hot-dip galvanized layer by an alloying treatment.

In addition, upper layer plating may be performed on the galvanized layer for the purpose of improving the coatability and weldability. In addition, in the steel sheet according to the present embodiment, various treatments such as a chromate treatment, a phosphate treatment, a lubricity improvement treatment, and a weldability improvement treatment may be performed on the hot-dip galvanized layer.

In a case where the plating layer is provided (in a case of a plated steel sheet having a base metal part and a plating layer formed on a surface of the base metal part), the surface serving as a reference at the t/4 position is the surface of the base metal part excluding the plating layer.

In addition, the chemical composition of the steel sheet is also a chemical composition of the base metal part excluding the plating layer.

### <Steel Member>

The steel member according to the present embodiment is obtained by processing the steel sheet according to the present embodiment (including the cases of a cold-rolled steel sheet and a plated steel sheet). That is, a processed portion and a non-processed portion are provided. Even in a case where the steel member is formed from the cold-rolled steel sheet, at least the non-processed portion does not change in chemical composition and microstructure. Therefore, the steel member according to the present embodiment has the same properties as the steel sheet according to the present embodiment in the non-processed portion. That is, at least the non-processed portion contains, as a chemical composition, by mass %, C: 0.180% or more and 0.400% or less, Si: 0.050% or more and 1.000% or less, Mn: 2.00% or more and 4.00% or less, Al: 0.10% or more and 2.00% or less, Ti: 0.010% or more and 0.200% or less, B: 0.0010% or more and 0.0100% or less, N: 0.0010% or more and 0.0100% or less, P: 0% or more and 0.0400% or less, S: 0% or more and 0.0100% or less, O: 0% or more and 0.0060% or less, Cr: 0% or more and 0.50% or less, Ni: 0% or more and 1.00% or less, Cu: 0% or more and 1.00% or less, Mo: 0% or more and 0.500% or less, Nb: 0% or more and 0.200% or less, V: 0% or more and 0.500% or less, W: 0% or more and 0.100% or less, Ta: 0% or more and 0.100% or less, Sn: 0% or more and 0.050% or less, Co: 0% or more and 0.500% or less, Sb: 0% or more and 0.050% or less, As: 0% or more and 0.050% or less, Mg: 0% or more and 0.050% or less, Ca: 0% or more and 0.040% or less, REM: 0% or more and 0.050% or less, Bi: 0% or more and 0.050% or less, Zr: 0% or more and 0.050% or less, Sr: 0% or more and 0.050% or less, and a remainder including Fe and impurities, when a thickness in units of mm is denoted by t, and a range from a t/8 position to a 3t/8 position in a thickness direction from a surface of the steel member is denoted by a t/4 position, at the t/4 position, a microstructure contains, by volume percentage, martensite: 95% or more, in which a volume percentage of tempered martensite is 95% or less, a prior austenite grain size is 7.0 μm or less, and a grain boundary segregation degree of Mn is 2.0 or less.

In the steel member according to the present embodiment, the non-processed portion is a flat portion that does not change in sheet thickness from the steel sheet serving as a material. The processed portion is a portion that changes in sheet thickness from the steel sheet serving as a material or a portion having a certain curvature.

The steel member according to the present embodiment is obtained from the cold-rolled steel sheet having a high tensile strength, excellent bendability, and superior LME resistance, and has the same properties as the cold-rolled steel sheet at least in the processed portion. Therefore, the steel member has excellent crash worthiness.

The steel member is applied, for example, to a bumper reinforcement, a side sill, a floor cross, or a center pillar.

The steel member may be joined to another member. In a case where the members are joined by welding, the non-processed portion does not include a welded part (nugget portion and heat-affected zone).

### <Manufacturing Method>

Next, a suitable example of a method of manufacturing the steel sheet according to the present embodiment will be described. According to this manufacturing method, the steel sheet according to the present embodiment can be obtained. However, the manufacturing method described below does not limit the range of the steel sheet according to the present embodiment. A steel sheet satisfying the requirements described above is regarded as the steel sheet according to the present embodiment regardless of the manufacturing method thereof.

Specifically, the steel sheet according to the present embodiment is obtained by a manufacturing method including the following steps:
(I) a hot rolling step of heating a slab having a predetermined chemical composition and performing hot rolling on the slab to obtain a hot-rolled steel sheet;
(II) a coiling step of cooling the hot-rolled steel sheet after the hot rolling step to a coiling temperature and coiling the hot-rolled steel sheet at the coiling temperature;
(III) a cold rolling step of performing cold rolling on the hot-rolled steel sheet after the coiling step at a rolling reduction of 20% or more to obtain a cold-rolled steel sheet;
(IV) a first annealing step of heating the cold-rolled steel sheet to a temperature of an Ac3 point or higher and 900° C. or lower, holding the cold-rolled steel sheet for 10 to 600 seconds, and cooling the cold-rolled steel sheet to a temperature of a Bs point or lower at an average cooling rate of 20° C./s or faster;
(V) a temper rolling step of performing temper rolling on the cold-rolled steel sheet after the first annealing step at a rolling reduction of 1.00% or less, as necessary; and
(VI) a second annealing step of heating the cold-rolled steel sheet after the first annealing step or after the temper rolling step to a temperature of the Ac3 point or higher and 900° C. or lower, holding the cold-rolled steel sheet for 10 to 600 seconds, cooling the cold-rolled steel sheet to a temperature range of an Ms point−100° C. or higher and the Bs point or lower at an average cooling rate of 20° C./s or faster, holding the cold-rolled steel sheet in the temperature range for 60 to 600 seconds, and cooling the cold-rolled steel sheet to 200° C. or lower at an average cooling rate of 20° C./s or faster.

In addition, the steel member according to the present embodiment can be obtained by subjecting the cold-rolled steel sheet obtained as described above (steel sheet according to the present embodiment) to the following steps:
(VII) a processing step of processing the steel sheet according to the present embodiment into a predetermined shape.

The Ac3 point is obtained by the following expression.

$$Ac 3 ( ° C . ) = 910 - 203 \times {[ C ]}^{1 / 2} + 44 \text{.7} \times [ Si ] - 30 \times [ Mn ] + 700 \times [ P ] - 20 \times [ Cu ] - 15.2 \times [ Ni ] - 11 \times [ Cr ] + 31 \text{.5} \times [ Mo ] + 4 \; 00 \times [ Ti ] + 104 \times [ V ] + 1 \; 20 \times [ Al ]$$

The Ms point is a temperature at which martensite begins to be generated during cooling after quenching. In the manufacturing method according to the present embodiment, a value that is calculated by the following expression is regarded as the Ms point.

$$Ms ( ° C . ) = 541 - 474 \times [ C ] / ( 1 - S α ) / 100 ) - 15 \times [ Si ] - 35 \times [ Mn ] - 17 \times [ Cr ] - 17 \times [ Ni ] + 19 \times [ Al ]$$

The Bs point is a temperature at which bainitic transformation starts during cooling after quenching. In the manufacturing method according to the present embodiment, a value calculated by the following expression is regarded as the Bs point.

$$Bs ( ° C . ) = 820 - 290 \times [ C ] / ( 1 - S α ) - 37 \times [ Si ] - 90 \times [ Mn ] - 65 \times [ Cr ] - 50 \times [ Ni ] + 70 \times [ Al ]$$

Here, [element symbol] included in the calculation expressions of the Ac3 point, the Ms point, and the Bs point indicates the amount (unit: mass %) of each element included in the steel sheet. The symbol Sa included in the expression is a ferrite fraction (unit: volume %) of the steel sheet at the point in time when the heating for quenching is ended.

However, it is difficult to obtain the area ratio of ferrite in the steel sheet during manufacturing. Therefore, a steel sheet which has undergone a temperature history similar to that of an actual steel sheet manufacturing process is prepared in advance, the area ratio of ferrite in a steel sheet center portion of the steel sheet is obtained, and the area ratio of ferrite is used for the calculation of the Ms point and the Bs point. The ferrite fraction of the steel sheet largely depends on the heating temperature for quenching. Therefore, in a case where the cooling conditions are examined, manufacturing conditions for the steps before cooling are first determined, and a steel sheet is manufactured under the above manufacturing conditions. By measuring a ferrite fraction of the steel sheet, Sa can be specified.

Hereinafter, each step will be described.

### [Hot Rolling Step]

In the hot rolling step, the slab is heated and hot-rolled to obtain a hot-rolled steel sheet. A heating temperature is not limited, but is, for example, 1,000° C. to 1,350° C. in consideration of a rolling force, scale loss, and the like.

A finish rolling finishing temperature is not limited, but is preferably set to 850° C. or higher. When a microstructure after the completion of the hot rolling step and the coiling step is an acicular structure, further refinement of the prior γ grain size is promoted. On the other hand, when the finish rolling finishing temperature is lower than 850° C., ferrite and/or pearlite having a small aspect ratio are generated, and it is difficult to increase a proportion of the acicular structure (bainite or martensite) in the steel sheet.

A method of manufacturing the slab is not limited. A steel piece having the above-described chemical composition (the same chemical composition as the steel sheet according to the present embodiment) may be manufactured by melting, refining, and casting. For example, the steel piece can be manufactured by continuous casting, a thin slab caster, or the like.

### [Coiling Step]

In the coiling step, the hot-rolled steel sheet after the hot rolling step is cooled to a coiling temperature and coiled.

Cooling conditions and the coiling temperature are not limited. However, as described above, by setting the finish rolling finishing temperature to 850° C. or higher, cooling the steel sheet to 500° C. or lower at an average cooling rate of 20° C./s or faster, and coiling the steel sheet in the temperature range, the structure of the steel sheet after the coiling step can be an acicular structure. In this case, refinement of the prior austenite grain size is more preferably achieved.

### [Cold Rolling Step]

In the cold rolling step, the hot-rolled steel sheet after the coiling step is cold-rolled at a rolling reduction (cumulative rolling reduction) of 20.0% or more. Accordingly, dislocations as diffusion paths for Mn can be introduced, and the grain boundary segregation degree of Mn can be reduced during the subsequent two annealing steps.

When the rolling reduction of the cold rolling is less than 20.0%, the grain boundary segregation degree of Mn in the finally obtained cold-rolled steel sheet increases. An upper limit of the rolling reduction is not limited, but may be set to 60.0% or less in terms of cold rolling load.

Before the cold rolling, pickling may be performed under known conditions as necessary.

### [First Annealing Step]

In the first annealing step, the cold-rolled steel sheet is heated to a temperature of the Ac3 point or higher and 900° C. or lower, held for 10 to 600 seconds, and then cooled to a temperature of the Bs point or lower at an average cooling rate of 20° C./s or faster.

As a result, the microstructure is an acicular structure (martensite or bainite). By forming the acicular structure, the prior austenite grain size in the finally obtained cold-rolled steel sheet can be made fine. In addition, the grain boundary segregation degree of Mn decreases due to diffusion through dislocations introduced in the cold rolling step.

When the heating temperature is lower than the Ac3 point or a holding time at the annealing temperature is shorter than 10 seconds, γ transformation becomes insufficient, and a desirable final microstructure cannot be obtained. On the other hand, when the annealing temperature is higher than 900° C., austenite grains become coarse. In addition, when the holding time at the annealing temperature is longer than 600 seconds, austenite grains become coarse and the productivity decreases.

In addition, when a cooling stop temperature is higher than the Bs point, ferrite, pearlite, or the like is generated, and the microstructure does not become an acicular structure.

### [Temper Rolling Step]

The temper rolling step is not essential, but in a case where the temper rolling step is performed, temper rolling is performed on the cold-rolled steel sheet after the first annealing step at a rolling reduction of 1.00% or less.

By performing the temper rolling, dislocations as the diffusion paths for Mn can be introduced, and in subsequent annealing, the grain boundary segregation degree of Mn can be reduced, which is preferable.

However, the rolling reduction may be set to 1.00% or less from the viewpoint of manufacturability.

### [Second Annealing Step]

In the second annealing step, the cold-rolled steel sheet after the first annealing step or after the temper rolling step is heated to a temperature (annealing temperature) of the Ac3 point or higher and 900° C. or lower, held for 10 to 600 seconds, cooled to a temperature range of the Ms point−100° C. or higher and the Bs point (° C.) or lower at an average cooling rate of 20° C./s or faster, held in the temperature range for 60 to 600 seconds, and then cooled to 200° C. or lower at an average cooling rate of 20° C./s or faster.

In this step, the acicular structure is reverse-transformed into a single austenite phase, and further transformed into a martensite-based structure, whereby the prior austenite grain size is refined. Simultaneously, diffusion of Mn occurs, thereby reducing the grain boundary segregation degree of Mn.

When the annealing temperature is lower than the Ac3 point or the holding time in the temperature range of Ac3 to 900° C. is shorter than 10 seconds, the transformation into austenite is not sufficient, and a predetermined microstructure cannot be obtained.

On the other hand, when the annealing temperature is higher than 900° C., austenite grains become coarse. In addition, when the holding time at the annealing temperature is longer than 600 seconds, austenite grains become coarse and the productivity decreases.

In addition, when the average cooling rate after heating is slower than 20° C./s or the cooling stop temperature (the subsequent holding temperature) is higher than the Bs point, ferrite, pearlite, or the like is generated, and a microstructure mainly containing martensite cannot be obtained.

When the cooling stop temperature is lower than the Ms point−100° C., the martensite finally obtained becomes brittle, leading to poor bendability.

In addition, when the holding time in a temperature range of the Ms point-100° C. or higher and the Bs point or lower is shorter than 60 seconds, the martensite finally obtained becomes brittle, leading to poor bendability. When the holding time is longer than 600 seconds, the volume percentage of martensite decreases.

The holding mentioned in the present embodiment may be such that the temperature of the steel sheet is in a range of the Ms point−100° C. or higher and the Bs point or lower, and a temperature change is permissible as long as the temperature is in this temperature range.

In a case where plating is performed, the steel sheet may be immersed in a hot-dip galvanizing bath during the holding. In addition, a hot-dip galvanized steel sheet may be subjected to an alloying treatment to obtain a hot-dip galvannealed steel sheet. In this case, holding of the temperature of the steel sheet described above can be performed by using heat applied to the steel sheet during hot-dip galvanizing and alloying. In any case, known conditions can be applied.

After the holding, the steel sheet is cooled to 200° C. or lower at an average cooling rate of 20° C./s or faster, whereby untransformed austenite is transformed into martensite.

### [Processing Step]

In the processing step, the cold-rolled steel sheet after the second annealing step is processed into a predetermined shape to obtain a steel member. The shape is not limited and may be determined depending on a component to which the shape is applied. For example, a hat shape, a U-shape, and a square columnar tubular shape can be mentioned.

### EXAMPLES

### Example 1

Slabs having the chemical compositions shown in Tables 1A to 1C were produced by continuous casting.

The slabs were heated to the heating temperatures shown in Tables 2A and 2B and hot-rolled such that the finish rolling finishing temperatures were the temperatures shown in Tables 2A and 2B to obtain hot-rolled steel sheets. However, in No. 38 and No. 42, slab cracking had occurred, and thus the subsequent tests were not performed.

The hot-rolled steel sheets after the hot rolling were cooled to the coiling temperatures at the average cooling rates shown in Tables 2A and 2B, coiled at the coiling temperatures, and cooled to room temperature.

Thereafter, the coiled hot-rolled steel sheets were uncoiled, pickled, and then cold-rolled at the cumulative rolling reductions shown in Tables 2A and 2B to obtain cold-rolled steel sheets having a thickness of 1.4 mm.

Thereafter, first annealing was performed on the steel sheets under the conditions shown in Tables 2A and 2B. At that time, the holding times at the heating temperature (annealing temperature) were set to 10 seconds or longer and 600 seconds or shorter.

Thereafter, temper rolling was performed under the conditions shown in Tables 2A and 2B (however, temper rolling was not performed in some examples (indicated by “-” in the tables)).

Thereafter, second annealing was performed under the conditions shown in Tables 3A and 3B. In addition, in some examples, during the holding of the second annealing, the steel sheet was immersed in a hot-dip galvanizing bath to form a hot-dip galvanized layer. Further, in some of the examples, an alloying treatment was performed to transform the hot-dip galvanized layer into a hot-dip galvannealed layer. In the table, CR indicates a cold-rolled steel sheet, GI indicates a hot-dip galvanized steel sheet having a hot-dip galvanized layer, and GA indicates a hot-dip galvannealed steel sheet having a hot-dip galvannealed layer.

For the structure of the base steel sheet at the t/4 position of the obtained steel sheet (cold-rolled steel sheet, hot-dip galvanized steel sheet, and hot-dip galvannealed steel sheet), the volume percentage of each phase, the prior austenite grain size, and the grain boundary segregation degree of Mn were measured by the above-described methods.

The results are shown in Tables 4A and 4B.

In addition, the tensile strength (TS), bendability, and LME resistance of the obtained steel sheet were evaluated in the following manner. The results are shown in Tables 4A and 4B.

### [Tensile Strength (TS)]

The tensile strength (TS) was obtained by collecting a JIS No. 5 tensile test piece from the steel sheet in a direction perpendicular to the rolling direction, and performing a tensile test in accordance with JIS Z 2241:2011.

When the tensile strength was 1,310 MPa or more, it was determined that a desired strength was achieved.

### [Bendability]

A bending test was performed in accordance with VDA238-100 of the VDA standard, and a maximum bending angle was obtained.

In a case where the maximum bending angle×TS was 130,000 MPa·degrees or more, it was determined that excellent bendability was achieved.

### [LME Resistance]

The LME resistance of the steel sheet was evaluated by the following method.

A commercially available hot-dip galvannealed steel sheet was prepared as an opposite material, and spot welding was performed on the obtained steel sheet and the opposite material, which were overlapped in two sheets, and the occurrence status of LME in the steel sheet was evaluated by cross-sectional observation.

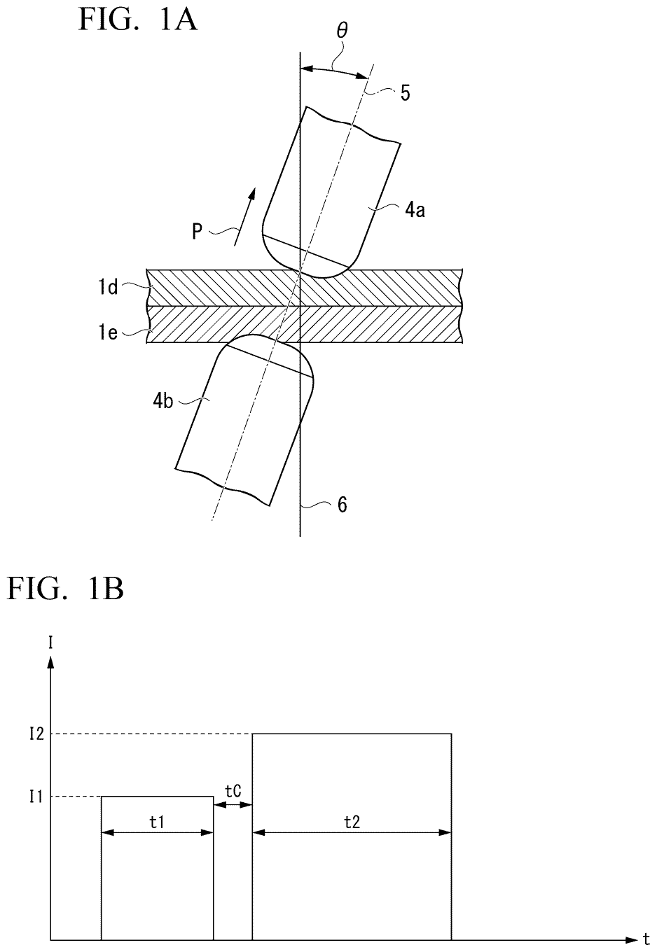

FIG. 1A shows an aspect in which two steel sheets are subjected to spot welding. During the welding, the opposite material (hot-dip galvannealed steel sheet) was always used as a steel sheet 1d, the steel sheet to be evaluated was always used as a steel sheet 1e, and the two sheets were overlapped and spot-welded.

In addition, FIG. 1B shows an aspect of current control when the two steel sheets are spot-welded. In a graph of FIG. 1B, a vertical axis I represents a current value, and a horizontal axis t represents time. The steel sheet 1d and the steel sheet 1e were overlapped and spot-welded with a pair of electrodes 4a and 4b. Welding conditions were as follows.
Electrodes 4a and 4b: DR type electrodes made of Cr—Cu, tip outer diameter: 8 mm, R: 40 mm
Weld force P: 450 kgf
Inclination angle of electrode (angle formed between an electrode centerline 5 and a vertical line 6) θ: 3°
Upslope: None
First energization time t1: 0.2 seconds
Non-energization interval tc: 0.04 seconds
Second energization time t2: 0.4 seconds
Current ratio I1/I2: 0.7
Holding time after end of energization: 0.1 seconds

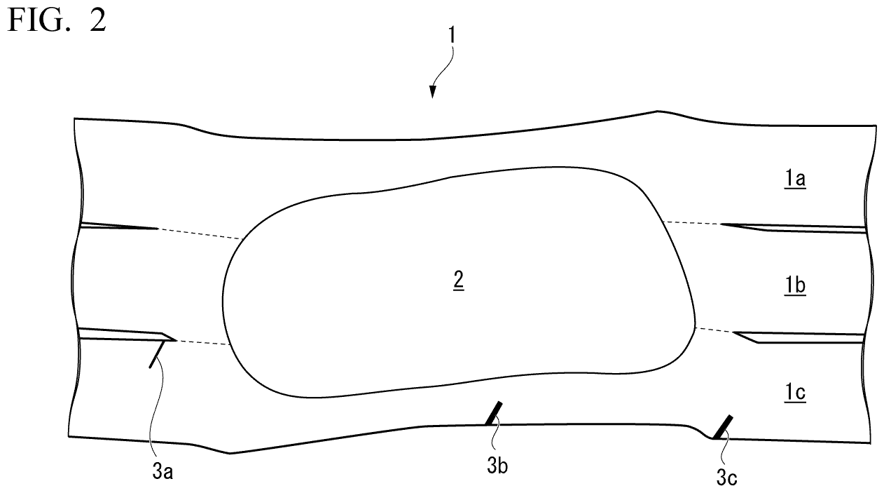

An aspect of the LME was evaluated by polishing a cross section of the steel sheet including a center of a nugget and observing the polished cross section by SEM in the same manner as the observation of the microstructure. At that time, the presence or absence of cracks was evaluated at three locations, that is, an inner crack 3a between the steel sheets, an outer crack 3b at a contact portion between the steel sheet and the spot welding electrode, and an outer crack 3c in a steel sheet portion not in direct contact with the electrode, as shown in FIG. 2. FIG. 2 is a view showing observation locations in a joint 1 obtained by overlapping and spot-welding three steel sheets, but the observation locations were similar even in a case of two steel sheets.

In a case where a crack having a length of more than 0.2 mm was observed at even one of the three locations, the presence of LME cracking was determined. In a case where there was no LME cracking, excellent LME resistance was determined.

Here, some of the steel sheets shown in the tables were not plated. However, even in a case where the steel sheet is not plated, a surface on a steel sheet 1e side is in contact with a galvanized surface of the steel sheet 1d. Therefore, even in a case where the surface on the steel sheet 1e side is a cold-rolled steel sheet that is not galvanized, the LME resistance can be evaluated.

TABLE 1A

| | Chemical composition (mass %, remainder: Fe and impurities) | | | | | | | | | |
|---|---|---|---|---|---|---|---|---|---|---|
| Component | C | Si | Mn | Al | Ti | B | N | P | S | O |
| A | 0.392 | 0.083 | 3.91 | 1.63 | 0.029 | 0.0020 | 0.0020 | 0.0202 | 0.0010 | 0.0004 |
| B | 0.260 | 0.781 | 2.60 | 0.27 | 0.022 | 0.0040 | 0.0020 | 0.0030 | 0.0008 | 0.0003 |
| C | 0.349 | 0.260 | 2.48 | 1.00 | 0.104 | 0.0060 | 0.0080 | 0.0077 | 0.0004 | 0.0004 |
| D | 0.224 | 0.613 | 3.05 | 0.32 | 0.053 | 0.0020 | 0.0090 | 0.0121 | 0.0007 | 0.0050 |
| E | 0.221 | 0.624 | 2.07 | 0.32 | 0.038 | 0.0030 | 0.0020 | 0.0034 | 0.0075 | 0.0004 |
| F | 0.296 | 0.502 | 3.21 | 0.37 | 0.163 | 0.0020 | 0.0070 | 0.0028 | 0.0010 | 0.0006 |
| G | 0.360 | 0.922 | 3.42 | 0.21 | 0.023 | 0.0020 | 0.0020 | 0.0023 | 0.0012 | 0.0044 |
| H | 0.337 | 0.832 | 3.15 | 0.24 | 0.136 | 0.0020 | 0.0020 | 0.0043 | 0.0007 | 0.0004 |
| I | 0.200 | 0.665 | 2.31 | 0.30 | 0.040 | 0.0080 | 0.0040 | 0.0326 | 0.0011 | 0.0008 |
| J | 0.379 | 0.065 | 3.42 | 1.07 | 0.154 | 0.0070 | 0.0080 | 0.0031 | 0.0027 | 0.0009 |
| K | 0.382 | 0.329 | 2.19 | 0.64 | 0.169 | 0.0090 | 0.0090 | 0.0030 | 0.0052 | 0.0003 |
| L | 0.249 | 0.839 | 2.85 | 0.24 | 0.031 | 0.0020 | 0.0030 | 0.0059 | 0.0006 | 0.0010 |
| M | 0.279 | 0.504 | 2.71 | 0.37 | 0.028 | 0.0020 | 0.0020 | 0.0049 | 0.0009 | 0.0015 |
| N | 0.362 | 0.057 | 3.57 | 0.99 | 0.172 | 0.0080 | 0.0020 | 0.0299 | 0.0081 | 0.0033 |
| O | 0.317 | 0.419 | 3.78 | 0.51 | 0.068 | 0.0090 | 0.0050 | 0.0024 | 0.0019 | 0.0004 |
| P | 0.256 | 0.063 | 3.66 | 1.01 | 0.175 | 0.0040 | 0.0090 | 0.0018 | 0.0012 | 0.0033 |
| Q | 0.338 | 0.807 | 2.45 | 0.26 | 0.181 | 0.0020 | 0.0050 | 0.0046 | 0.0008 | 0.0016 |
| R | 0.348 | 0.507 | 2.85 | 1.19 | 0.045 | 0.0020 | 0.0020 | 0.0040 | 0.0015 | 0.0006 |
| S | 0.293 | 0.588 | 3.56 | 0.34 | 0.027 | 0.0090 | 0.0030 | 0.0059 | 0.0005 | 0.0003 |
| T | 0.299 | 0.880 | 2.55 | 0.23 | 0.027 | 0.0050 | 0.0090 | 0.0030 | 0.0009 | 0.0004 |
| U | 0.200 | 0.672 | 2.72 | 0.30 | 0.102 | 0.0090 | 0.0020 | 0.0304 | 0.0012 | 0.0006 |
| V | 0.302 | 0.303 | 3.79 | 0.70 | 0.030 | 0.0090 | 0.0090 | 0.0052 | 0.0008 | 0.0006 |
| W | 0.221 | 0.197 | 3.70 | 0.87 | 0.070 | 0.0070 | 0.0040 | 0.0339 | 0.0026 | 0.0005 |
| X | 0.388 | 0.053 | 3.92 | 0.71 | 0.159 | 0.0030 | 0.0020 | 0.0205 | 0.0010 | 0.0004 |
| Y | 0.238 | 0.694 | 2.34 | 0.30 | 0.031 | 0.0020 | 0.0070 | 0.0108 | 0.0006 | 0.0050 |
| Z | 0.250 | 0.429 | 3.30 | 0.45 | 0.163 | 0.0020 | 0.0020 | 0.0030 | 0.0009 | 0.0004 |
| AA | 0.189 | 0.970 | 2.09 | 0.20 | 0.025 | 0.0020 | 0.0080 | 0.0020 | 0.0085 | 0.0004 |
| AB | 0.275 | 0.726 | 2.19 | 0.28 | 0.142 | 0.0020 | 0.0020 | 0.0046 | 0.0006 | 0.0011 |
| AC | 0.188 | 0.435 | 2.97 | 0.43 | 0.051 | 0.0080 | 0.0020 | 0.0025 | 0.0055 | 0.0003 |
| AD | 0.320 | 0.706 | 3.14 | 0.30 | 0.030 | 0.0020 | 0.0020 | 0.0034 | 0.0076 | 0.0044 |
| AE | 0.174 | 0.437 | 3.84 | 0.42 | 0.166 | 0.0030 | 0.0020 | 0.0029 | 0.0004 | 0.0020 |
| AF | 0.406 | 0.800 | 2.92 | 0.27 | 0.025 | 0.0080 | 0.0090 | 0.0024 | 0.0010 | 0.0004 |
| AG | 0.324 | 0.019 | 3.63 | 0.31 | 0.118 | 0.0040 | 0.0020 | 0.0300 | 0.0042 | 0.0004 |
| AH | 0.220 | 1.033 | 2.28 | 0.30 | 0.031 | 0.0060 | 0.0090 | 0.0018 | 0.0010 | 0.0006 |
| AI | 0.195 | 0.130 | 1.93 | 0.44 | 0.030 | 0.0020 | 0.0020 | 0.0067 | 0.0010 | 0.0051 |
| AJ | 0.271 | 0.178 | 4.07 | 0.44 | 0.176 | 0.0020 | 0.0040 | 0.0100 | 0.0009 | 0.0007 |
| AK | 0.385 | 0.989 | 2.24 | 0.05 | 0.167 | 0.0070 | 0.0050 | 0.0249 | 0.0077 | 0.0044 |
| AL | 0.193 | 0.395 | 2.53 | 2.07 | 0.054 | 0.0090 | 0.0030 | 0.0034 | 0.0085 | 0.0008 |
| AM | 0.364 | 0.604 | 3.73 | 0.33 | 0.004 | 0.0090 | 0.0020 | 0.0017 | 0.0082 | 0.0004 |
| AN | 0.198 | 0.900 | 3.36 | 0.22 | 0.206 | 0.0080 | 0.0030 | 0.0088 | 0.0055 | 0.0006 |
| AO | 0.285 | 0.340 | 3.56 | 0.55 | 0.033 | 0.0007 | 0.0090 | 0.0031 | 0.0008 | 0.0002 |
| AP | 0.245 | 0.231 | 3.46 | 1.20 | 0.026 | 0.0150 | 0.0070 | 0.0105 | 0.0007 | 0.0049 |

TABLE 1B

| | Chemical composition (mass %, remainder: Fe and impurities) | | | | | | | | | | | |
|---|---|---|---|---|---|---|---|---|---|---|---|---|
| Component | Cr | Ni | Cu | Mo | Nb | V | W | Ta | Sn | Co | As | Sb |
| A | — | — | — | — | — | — | — | — | — | — | — | — |
| B | — | — | — | — | — | — | — | — | — | — | — | — |
| C | — | — | — | — | — | — | — | — | — | — | — | — |
| D | — | — | — | — | — | — | — | — | — | — | — | — |
| E | — | — | — | — | — | — | — | — | — | — | — | — |
| F | — | — | — | — | — | — | — | — | — | — | — | — |
| G | — | — | — | — | — | — | — | — | — | — | — | — |
| H | — | — | — | — | — | — | — | — | — | — | — | — |
| I | — | — | — | — | — | — | — | — | — | — | — | — |
| J | — | — | — | — | — | — | — | — | — | — | — | — |
| K | — | — | — | — | — | — | — | — | — | — | — | — |
| L | — | — | — | — | — | — | — | — | — | — | — | — |
| M | — | — | — | — | — | — | — | — | — | — | — | — |
| N | — | — | — | — | — | — | — | — | — | — | — | — |
| O | — | — | — | — | — | — | — | — | — | — | — | — |
| P | 0.28 | — | — | 0.032 | — | — | — | — | — | — | — | — |
| Q | — | 0.26 | 0.11 | — | — | — | 0.009 | — | — | — | — | — |
| R | 0.03 | — | 0.05 | 0.033 | 0.017 | — | — | — | — | — | — | — |
| S | 0.08 | — | — | 0.126 | 0.013 | — | 0.004 | — | — | — | — | — |
| T | — | — | — | — | 0.019 | 0.055 | — | — | — | — | — | — |
| U | 0.04 | — | — | 0.029 | — | — | — | — | — | — | — | — |
| V | — | 0.13 | 0.05 | — | — | — | 0.004 | — | — | — | — | — |
| W | 0.03 | — | 0.07 | 0.054 | 0.036 | — | — | — | — | — | — | — |
| X | 0.08 | — | — | 0.059 | 0.017 | — | 0.018 | — | — | — | — | — |
| Y | 0.43 | — | — | — | 0.060 | 0.092 | — | — | — | — | — | — |
| Z | 0.04 | — | — | 0.048 | — | — | — | 0.007 | — | — | — | 0.003 |
| AA | — | 0.07 | 0.29 | — | — | — | 0.007 | 0.006 | 0.008 | — | 0.005 | — |
| AB | 0.38 | — | 0.07 | 0.278 | 0.026 | — | — | 0.007 | — | — | 0.010 | 0.014 |
| AC | 0.13 | — | — | 0.421 | 0.029 | — | 0.005 | — | 0.004 | 0.068 | — | — |
| AD | — | — | — | — | 0.033 | 0.041 | — | 0.009 | — | — | — | 0.004 |
| AE | — | — | — | 0.237 | — | 0.259 | — | — | — | 0.254 | — | — |
| AF | — | 0.49 | 0.50 | 0.236 | 0.100 | 0.238 | — | 0.052 | 0.026 | 0.249 | — | 0.025 |
| AG | 0.25 | 0.48 | 0.51 | — | 0.102 | 0.255 | 0.053 | 0.049 | 0.025 | — | 0.024 | 0.026 |
| AH | — | — | 0.50 | 0.258 | — | 0.252 | — | 0.050 | — | 0.258 | 0.024 | — |
| AI | — | — | 0.51 | — | — | — | — | 0.052 | — | 0.251 | 0.026 | 0.024 |
| AJ | 0.26 | 0.50 | 0.47 | 0.265 | — | 0.247 | 0.052 | — | — | — | 0.024 | — |
| AK | — | — | — | — | 0.104 | 0.246 | — | 0.052 | — | — | 0.024 | — |
| AL | 0.24 | 0.48 | — | 0.260 | 0.103 | — | 0.051 | 0.048 | 0.024 | — | 0.025 | 0.026 |
| AM | 0.25 | 0.49 | — | — | 0.105 | — | 0.047 | 0.047 | — | — | — | 0.026 |
| AN | 0.26 | — | — | — | 0.102 | — | 0.050 | 0.053 | 0.024 | — | — | 0.024 |
| AO | 0.25 | 0.53 | 0.52 | 0.240 | 0.101 | — | — | 0.051 | 0.025 | — | — | — |
| AP | 0.26 | 0.53 | 0.52 | 0.249 | — | 0.248 | — | — | — | 0.255 | — | 0.024 |

TABLE 1C

| | Chemical composition (mass %, remainder: Fe and impurities) | | | | | | | | Ac3 |
|---|---|---|---|---|---|---|---|---|---|
| Component | Mg | Ca | Y | La | Ce | Zr | Bi | Sr | (° C.) |
| A | — | — | — | — | — | — | — | — | 891 |
| B | — | — | — | — | — | — | — | — | 807 |
| C | — | — | — | — | — | — | — | — | 894 |
| D | — | — | — | — | — | — | — | — | 818 |
| E | — | — | — | — | — | — | — | — | 836 |
| F | — | — | — | — | — | — | — | — | 837 |
| G | — | — | — | — | — | — | — | — | 763 |
| H | — | — | — | — | — | — | — | — | 821 |
| I | — | — | — | — | — | — | — | — | 854 |
| J | — | — | — | — | — | — | — | — | 878 |
| K | — | — | — | — | — | — | — | — | 880 |
| L | — | — | — | — | — | — | — | — | 806 |
| M | — | — | — | — | — | — | — | — | 803 |
| N | — | — | — | — | — | — | — | — | 892 |
| O | — | — | — | — | — | — | — | — | 791 |
| P | — | — | — | — | — | — | — | — | 891 |
| Q | — | — | — | — | — | — | — | — | 855 |
| R | — | — | — | — | — | — | — | — | 891 |
| S | — | — | — | — | — | — | — | — | 778 |
| T | — | — | — | — | — | — | — | — | 808 |
| U | — | — | — | — | — | — | — | — | 866 |
| V | — | — | — | — | — | — | — | — | 795 |
| W | — | — | — | — | — | — | — | — | 868 |
| X | — | — | — | — | — | — | — | — | 832 |
| Y | — | — | — | — | — | — | — | — | 833 |
| Z | — | — | — | — | — | — | — | — | 851 |
| AA | — | — | — | — | — | — | — | — | 831 |
| AB | 0.005 | — | — | — | 0.005 | 0.036 | — | — | 867 |
| AC | — | 0.012 | 0.003 | 0.036 | — | — | — | 0.004 | 838 |
| AD | 0.028 | — | — | 0.005 | — | 0.003 | 0.038 | — | 787 |
| AE | — | — | 0.026 | — | 0.024 | — | — | — | 883 |
| AF | 0.024 | 0.021 | 0.026 | — | — | 0.026 | 0.025 | 0.024 | 788 |
| AG | — | 0.020 | — | — | — | — | — | — | 798 |
| AH | 0.025 | 0.021 | 0.024 | — | — | — | 0.026 | 0.025 | 867 |
| AI | 0.026 | — | 0.026 | 0.024 | — | 0.026 | 0.024 | 0.024 | 828 |
| AJ | 0.026 | — | — | — | 0.026 | 0.025 | — | 0.024 | 835 |
| AK | — | — | 0.026 | 0.024 | 0.026 | 0.026 | — | — | 877 |
| AL | 0.026 | — | 0.026 | 0.024 | — | — | — | 0.024 | 1033 |
| AM | — | — | — | — | — | 0.025 | 0.025 | 0.025 | 735 |
| AN | 0.024 | 0.020 | — | — | — | — | — | 0.024 | 871 |
| AO | 0.024 | 0.019 | — | — | — | 0.025 | — | — | 778 |
| AP | — | — | — | 0.025 | — | 0.026 | — | — | 890 |

TABLE 2A

| | | | Hot rolling step | | | Cold | | | | |
|---|---|---|---|---|---|---|---|---|---|---|
| | | | | Average | | rolling | | | | Temper |
| | | | Finish | cooling | | step | First annealing step | | | rolling |
| | | | rolling | rate to | | Cumulative | | Average | Cooling | step |
| | | | finishing | coiling | Coiling | rolling | Heating | cooling | stop | Rolling |
| | | | temperature | temperature | temperature | reduction | temperature | rate | temperature | reduction |
| No. | Component | Classification | [° C.] | [° C./s] | [° C.] | [%] | [° C.] | [° C./s] | [° C.] | [%] |
| 1 | A | Example | 903 | 124 | 470 | 61.6 | 892 | 44 | 358 | 0.80 |
| 2 | B | Example | 946 | 171 | 449 | 35.0 | 868 | 29 | 413 | 0.30 |
| 3 | C | Example | 950 | 188 | 478 | 32.1 | 896 | 95 | 431 | 0.72 |
| 4 | D | Example | 950 | 186 | 407 | 46.3 | 900 | 93 | 387 | 0.79 |
| 5 | E | Example | 950 | 76 | 465 | 21.7 | 837 | 88 | 398 | 0.37 |
| 6 | F | Example | 920 | 186 | 456 | 50.4 | 844 | 92 | 343 | 0.05 |
| 7 | G | Example | 950 | 185 | 466 | 55.4 | 763 | 33 | 336 | 0.22 |
| 8 | H | Example | 900 | 189 | 481 | 48.7 | 845 | 94 | 305 | 0.46 |
| 9 | I | Example | 941 | 50 | 449 | 27.7 | 887 | 89 | 461 | 0.94 |
| 10 | J | Example | 946 | 190 | 184 | 68.0 | 889 | 93 | 442 | 0.48 |
| 11 | K | Example | 933 | 45 | 439 | 24.8 | 896 | 93 | 478 | 0.12 |
| 12 | L | Example | 949 | 160 | 336 | 41.4 | 872 | 65 | 371 | 0.65 |
| 13 | M | Example | 936 | 181 | 161 | 37.7 | 812 | 79 | 324 | 0.58 |
| 14 | N | Example | 950 | 179 | 210 | 59.1 | 892 | 93 | 451 | 0.89 |
| 15 | O | Example | 950 | 183 | 470 | 64.5 | 803 | 93 | 397 | 0.16 |
| 16 | P | Example | 947 | 126 | 481 | 23.2 | 891 | 36 | 363 | 0.71 |
| 17 | Q | Example | 925 | 72 | 469 | 69.0 | 895 | 94 | 417 | 0.01 |
| 18 | R | Example | 901 | 181 | 456 | 40.8 | 900 | 91 | 324 | 0.96 |
| 19 | S | Example | 910 | 183 | 406 | 35.5 | 803 | 97 | 393 | 0.17 |
| 20 | T | Example | 924 | 153 | 462 | 31.0 | 834 | 87 | 308 | 0.35 |
| 21 | U | Example | 906 | 43 | 470 | 49.3 | 900 | 31 | 422 | 0.59 |
| 22 | V | Example | 930 | 54 | 223 | 53.0 | 871 | 95 | 348 | 0.62 |
| 23 | W | Example | 936 | 190 | 470 | 61.7 | 872 | 96 | 415 | 0.32 |
| 24 | X | Example | 950 | 186 | 317 | 55.7 | 853 | 63 | 381 | 0.51 |
| 25 | Y | Example | 949 | 190 | 482 | 28.1 | 844 | 91 | 332 | 0.13 |
| 26 | Z | Example | 950 | 174 | 179 | 39.5 | 885 | 44 | 448 | 0.91 |
| 27 | AA | Example | 944 | 190 | 478 | 44.9 | 890 | 95 | 489 | 0.74 |
| 28 | AB | Example | 947 | 186 | 471 | 65.0 | 897 | 80 | 406 | 0.84 |
| 29 | AC | Example | 950 | 184 | 446 | 58.5 | 882 | 92 | 442 | 0.43 |
| 30 | AD | Example | 950 | 189 | 162 | 24.6 | 811 | 93 | 369 | 0.25 |
| 31 | AE | Comparative | 929 | 184 | 211 | 40.5 | 897 | 87 | 398 | 0.95 |
| | | Example | | | | | | | | |
| 32 | AF | Comparative | 949 | 171 | 166 | 61.4 | 829 | 96 | 356 | 0.92 |
| | | Example | | | | | | | | |
| 33 | AG | Comparative | 929 | 123 | 469 | 27.9 | 842 | 91 | 358 | 0.79 |
| | | Example | | | | | | | | |
| 34 | AH | Comparative | 950 | 155 | 450 | 37.6 | 877 | 43 | 468 | 0.30 |
| | | Example | | | | | | | | |
| 35 | AI | Comparative | 950 | 191 | 463 | 58.4 | 840 | 90 | 312 | 0.68 |
| | | Example | | | | | | | | |
| 36 | AJ | Comparative | 905 | 179 | 464 | 26.6 | 835 | 96 | 352 | 0.22 |
| | | Example | | | | | | | | |

TABLE 2B

| | | | Hot rolling step | | | Cold | | | | |
|---|---|---|---|---|---|---|---|---|---|---|
| | | | | Average | | rolling | | | | Temper |
| | | | Finish | cooling | | step | First annealing step | | | rolling |
| | | | rolling | rate to | | Cumulative | | Average | Cooling | step |
| | | | finishing | coiling | Coiling | rolling | Heating | cooling | stop | Rolling |
| | | | temperature | temperature | temperature | reduction | temperature | rate | temperature | reduction |
| No. | Component | Classification | [° C.] | [° C./s] | [° C.] | [%] | [° C.] | [° C./s] | [° C.] | [%] |
| 37 | AK | Comparative | 945 | 69 | 326 | 33.8 | 882 | 34 | 467 | 0.83 |
| | | Example | | | | | | | | |
| 38 | AL | Comparative | 904 | Subsequent tests were canceled due to slab cracking. | | | | | | |
| | | Example | | | | | | | | |
| 39 | AM | Comparative | 944 | 48 | 441 | 54.1 | 899 | 93 | 321 | 0.19 |
| | | Example | | | | | | | | |
| 40 | AN | Comparative | 950 | 56 | 475 | 65.0 | 881 | 32 | 339 | 0.39 |
| | | Example | | | | | | | | |
| 41 | AO | Comparative | 948 | 184 | 478 | 23.3 | 792 | 95 | 368 | 0.59 |
| | | Example | | | | | | | | |
| 42 | AP | Comparative | 950 | Subsequent tests were canceled due to slab cracking. | | | | | | |
| | | Example | | | | | | | | |
| 43 | A | Example | 940 | 188 | 153 | 68.9 | 891 | 66 | 384 | 0.50 |
| 44 | B | Example | 931 | 182 | 396 | 47.2 | 807 | 93 | 323 | 0.10 |
| 45 | C | Example | 919 | 189 | 462 | 52.1 | 895 | 92 | 442 | 0.44 |
| 46 | D | Example | 940 | 181 | 456 | 63.8 | 853 | 92 | 457 | 0.82 |
| 47 | E | Example | 950 | 163 | 465 | 58.2 | 900 | 95 | 387 | 0.89 |
| 48 | F | Example | 918 | 187 | 153 | 47.6 | 858 | 81 | 317 | 0.37 |
| 49 | G | Example | 945 | 189 | 163 | 29.3 | 763 | 35 | 314 | 0.06 |
| 50 | H | Example | 913 | 75 | 430 | 42.7 | 878 | 44 | 409 | 0.75 |
| 51 | I | Example | 950 | 187 | 219 | 44.5 | 899 | 93 | 431 | 0.44 |
| 52 | J | Example | 922 | 170 | 482 | 55.8 | 878 | 92 | 395 | 0.96 |
| 53 | K | Example | 924 | 124 | 465 | 24.2 | 893 | 63 | 411 | 0.16 |
| 54 | L | Example | 950 | 187 | 396 | 21.2 | 867 | 31 | 360 | 0.56 |
| 55 | M | Example | 929 | 182 | 480 | 35.4 | 866 | 95 | 351 | 0.71 |
| 56 | N | Example | 950 | 188 | 472 | 32.2 | 893 | 88 | 331 | 0.33 |
| 57 | O | Example | 943 | 55 | 333 | 60.0 | 886 | 93 | 394 | 0.66 |
| 58 | P | Example | 941 | 187 | 469 | 37.4 | 899 | 95 | 451 | 0.50 |
| 59 | Q | Example | 947 | 45 | 471 | 67.0 | 900 | 94 | 379 | 0.13 |
| 60 | R | Example | 945 | 173 | 445 | 52.9 | 893 | 95 | 498 | 0.25 |
| 61 | S | Example | 950 | 15 | 467 | 48.3 | 875 | 87 | 405 | 0.73 |
| 62 | V | Example | 907 | 188 | 510 | 25.8 | 795 | 95 | 328 | 0.79 |
| 63 | W | Comparative | 916 | 182 | 466 | 18.7 | 875 | 91 | 407 | 0.57 |
| | | Example | | | | | | | | |
| 64 | Y | Comparative | 937 | 181 | 176 | 33.1 | 815 | 91 | 353 | 0.83 |
| | | Example | | | | | | | | |
| 65 | AA | Comparative | 940 | 192 | 436 | 23.3 | 869 | 17 | 367 | 0.42 |
| | | Example | | | | | | | | |
| 66 | AD | Comparative | 950 | 181 | 442 | 63.9 | 793 | 93 | 489 | 0.61 |
| | | Example | | | | | | | | |
| 67 | C | Example | 912 | 151 | 446 | 30.2 | 898 | 95 | 305 | — |
| 68 | E | Comparative | 923 | 54 | 454 | 44.7 | 837 | 93 | 401 | 0.15 |
| | | Example | | | | | | | | |
| 69 | G | Comparative | 939 | 188 | 478 | 52.9 | 808 | 95 | 380 | 0.99 |
| | | Example | | | | | | | | |
| 70 | Q | Comparative | 920 | 75 | 466 | 49.0 | 885 | 96 | 415 | 0.01 |
| | | Example | | | | | | | | |
| 71 | J | Comparative | 930 | 169 | 472 | 47.0 | 886 | 92 | 391 | 0.29 |
| | | Example | | | | | | | | |
| 72 | L | Comparative | 939 | 191 | 468 | 37.1 | 818 | 34 | 444 | 0.51 |
| | | Example | | | | | | | | |
| 73 | M | Example | 836 | 182 | 480 | 35.4 | 866 | 79 | 324 | 0.58 |
| 74 | N | Comparative | 950 | 188 | 472 | 59.1 | 893 | 88 | 331 | 0.33 |
| | | Example | | | | | | | | |
| 75 | O | Comparative | 943 | 183 | 470 | 60.0 | 886 | 93 | 397 | 0.16 |
| | | Example | | | | | | | | |
| 76 | P | Comparative | 911 | 178 | 466 | 34.7 | 899 | 96 | 448 | 0.51 |
| | | Example | | | | | | | | |

TABLE 3A

| | Second annealing step | | | | | | | | |
|---|---|---|---|---|---|---|---|---|---|
| | | | | Holding time in | | | | | |
| | | | | temperature | | | | | |
| | | | | range of Ms point - | Average | | | | |
| | | Average | Cooling | 100° C. or higher | cooling | Cooling | | Note | |
| | Heating | cooling | stop | and Bs point or | rate after | stop | | Bs | Ms |
| | temperature | rate | temperature | lower | holding | temperature | Kind of | point | point |
| No. | [° C.] | [° C./s] | [° C.] | [s] | [° C./s] | [° C.] | plating*¹ | [° C.] | [° C.] |
| 1 | 895 | 43 | 450 | 576 | 95 | 101 | GA | 465 | 248 |
| 2 | 898 | 33 | 392 | 115 | 87 | 200 | CR | 501 | 320 |
| 3 | 898 | 87 | 422 | 165 | 41 | 195 | GI | 556 | 304 |
| 4 | 821 | 94 | 407 | 355 | 45 | 196 | CR | 480 | 325 |
| 5 | 888 | 89 | 275 | 479 | 93 | 114 | CR | 569 | 361 |
| 6 | 896 | 84 | 438 | 90 | 93 | 200 | CR | 453 | 288 |
| 7 | 776 | 93 | 324 | 385 | 95 | 200 | GA | 388 | 241 |
| 8 | 853 | 90 | 370 | 235 | 95 | 109 | GI | 425 | 263 |
| 9 | 898 | 95 | 365 | 518 | 29 | 174 | CR | 550 | 361 |
| 10 | 878 | 95 | 303 | 289 | 92 | 194 | GI | 475 | 261 |
| 11 | 889 | 30 | 402 | 273 | 81 | 200 | CR | 545 | 291 |
| 12 | 880 | 93 | 332 | 184 | 94 | 200 | CR | 477 | 315 |
| 13 | 862 | 92 | 373 | 541 | 67 | 154 | GA | 502 | 313 |
| 14 | 892 | 95 | 390 | 448 | 103 | 200 | CR | 461 | 262 |
| 15 | 896 | 65 | 351 | 322 | 75 | 167 | CR | 408 | 262 |
| 16 | 894 | 30 | 384 | 476 | 93 | 121 | GI | 467 | 305 |
| 17 | 862 | 92 | 463 | 158 | 95 | 189 | GI | 477 | 283 |
| 18 | 891 | 90 | 352 | 567 | 95 | 191 | CR | 525 | 291 |
| 19 | 798 | 93 | 317 | 352 | 92 | 163 | GI | 411 | 274 |
| 20 | 843 | 43 | 371 | 133 | 80 | 200 | GA | 487 | 301 |
| 21 | 877 | 88 | 250 | 239 | 92 | 183 | GA | 511 | 346 |
| 22 | 894 | 94 | 383 | 91 | 81 | 200 | GI | 423 | 272 |
| 23 | 890 | 92 | 360 | 510 | 96 | 191 | GI | 475 | 320 |
| 24 | 843 | 93 | 354 | 388 | 88 | 200 | GA | 397 | 231 |
| 25 | 833 | 82 | 311 | 287 | 36 | 196 | GI | 508 | 334 |
| 26 | 858 | 97 | 433 | 430 | 92 | 188 | CR | 464 | 308 |
| 27 | 880 | 94 | 408 | 196 | 42 | 92 | CR | 552 | 366 |
| 28 | 884 | 36 | 465 | 557 | 91 | 200 | GI | 511 | 322 |
| 29 | 881 | 67 | 434 | 248 | 53 | 134 | GI | 504 | 347 |
| 30 | 802 | 93 | 395 | 338 | 92 | 122 | GI | 439 | 275 |
| 31 | 897 | 95 | 377 | 588 | 93 | 200 | GI | 437 | 326 |
| 32 | 800 | 92 | 389 | 555 | 85 | 151 | GA | 404 | 231 |
| 33 | 899 | 42 | 307 | 281 | 93 | 81 | GA | 380 | 254 |
| 34 | 870 | 32 | 476 | 471 | 95 | 195 | GA | 534 | 347 |
| 35 | 885 | 89 | 330 | 186 | 93 | 195 | GI | 616 | 387 |
| 36 | 836 | 96 | 318 | 341 | 95 | 117 | GA | 357 | 263 |

*¹CR: cold-rolled steel sheet, GI: hot-dip galvanized steel sheet, GA: hot-dip galvannealed steel sheet

TABLE 3B

| | Second annealing step | | | | | | | | |
|---|---|---|---|---|---|---|---|---|---|
| | | | | Holding time in | | | | | |
| | | | | temperature | | | | | |
| | | | | range of Ms | | | | | |
| | | | | point - 100° C. | Average | | | | |
| | | Average | Cooling | or higher and | cooling | Cooling | | Note | |
| | Heating | cooling | stop | Bs point or | rate after | stop | | Bs | Ms |
| | temperature | rate | temperature | lower | holding | temperature | Kind of | point | point |
| No. | [° C.] | [° C./s] | [° C.] | [s] | [° C./s] | [° C.] | plating*¹ | [° C.] | [° C.] |
| 37 | 899 | 83 | 364 | 81 | 92 | 52 | GA | 474 | 266 |
| 38 | Subsequent tests were canceled due to slab cracking. | | | | | | | | |
| 39 | 742 | 92 | 314 | 218 | 32 | 147 | CR | 339 | 223 |
| 40 | 872 | 35 | 414 | 120 | 93 | 168 | CR | 425 | 316 |
| 41 | 859 | 95 | 392 | 374 | 92 | 162 | GA | 400 | 273 |
| 42 | Subsequent tests were canceled due to slab cracking. | | | | | | | | |
| 43 | 891 | 95 | 382 | 413 | 31 | 84 | GI | 465 | 248 |
| 44 | 900 | 66 | 353 | 146 | 91 | 197 | CR | 501 | 320 |
| 45 | 898 | 89 | 496 | 511 | 94 | 200 | CR | 556 | 304 |
| 46 | 839 | 91 | 383 | 181 | 92 | 156 | GA | 480 | 325 |
| 47 | 880 | 93 | 498 | 227 | 90 | 61 | GI | 569 | 361 |
| 48 | 884 | 91 | 448 | 386 | 67 | 199 | GA | 453 | 288 |
| 49 | 893 | 92 | 324 | 244 | 31 | 199 | GI | 388 | 241 |
| 50 | 879 | 31 | 398 | 513 | 52 | 195 | GA | 425 | 263 |
| 51 | 856 | 45 | 475 | 566 | 33 | 196 | GA | 550 | 361 |
| 52 | 897 | 81 | 312 | 558 | 44 | 191 | GI | 475 | 261 |
| 53 | 890 | 90 | 353 | 441 | 91 | 197 | GI | 545 | 291 |
| 54 | 879 | 96 | 330 | 103 | 84 | 196 | GI | 477 | 315 |
| 55 | 892 | 95 | 361 | 488 | 95 | 169 | GI | 502 | 313 |
| 56 | 899 | 33 | 439 | 379 | 35 | 148 | CR | 461 | 262 |
| 57 | 899 | 92 | 364 | 293 | 95 | 162 | GI | 408 | 262 |
| 58 | 898 | 63 | 426 | 151 | 91 | 193 | CR | 467 | 305 |
| 59 | 878 | 95 | 377 | 85 | 96 | 194 | GI | 477 | 283 |
| 60 | 900 | 92 | 414 | 325 | 34 | 200 | GI | 525 | 291 |
| 61 | 897 | 32 | 324 | 437 | 95 | 199 | GA | 411 | 274 |
| 62 | 801 | 95 | 388 | 215 | 31 | 200 | GI | 423 | 272 |
| 63 | 895 | 95 | 400 | 410 | 95 | 135 | CR | 475 | 320 |
| 64 | 899 | 92 | 446 | 355 | 90 | 200 | GI | 508 | 334 |
| 65 | 832 | 87 | 361 | 295 | 96 | 152 | GA | 552 | 366 |
| 66 | 805 | 93 | 354 | 555 | 87 | 55 | GI | 439 | 275 |
| 67 | 898 | 93 | 486 | 466 | 95 | 59 | GI | 556 | 304 |
| 68 | 827 | 36 | 441 | 493 | 88 | 141 | CR | 569 | 361 |
| 69 | 814 | 18 | 312 | 155 | 93 | 200 | GI | 388 | 241 |
| 70 | 864 | 91 | 173 | 160 | 90 | 190 | GA | 477 | 283 |
| 71 | 878 | 52 | 505 | 307 | 95 | 187 | GA | 475 | 261 |
| 72 | 807 | 95 | 428 | 622 | 63 | 200 | GA | 477 | 315 |
| 73 | 892 | 95 | 361 | 488 | 95 | 64 | GA | 437 | 326 |
| 74 | 892 | 33 | 439 | 379 | 15 | 132 | CR | 404 | 231 |
| 75 | 896 | 65 | 364 | 293 | 95 | 281 | GA | 380 | 254 |
| 76 | 898 | 63 | 426 | 41 | 91 | 193 | CR | 534 | 347 |

*¹CR: cold-rolled steel sheet, GI: hot-dip galvanized steel sheet, GA: hot-dip galvannealed steel sheet

TABLE 4A

| | | | t/4 position microstructure | | | | | | | |
|---|---|---|---|---|---|---|---|---|---|---|
| | | | | | | | Grain | | | |
| | | | | | | | boundary | | | |
| | | | | | | | segregation | | | |
| | | | | | | | degree of | | | |
| | | | | | | | Mn (grain | | | |
| | | | | Tempered | | Prior | boundary | Propertics | | |
| | | | Martensite | martensite | Remainder | austenite | concentration/ | | | Presence or |
| | | | volume | volume | volume | grain | base metal | | TS × bending | absence of |
| | | | percentage | percentage | percentage | size | concentration) | TS | angle | LME |
| No. | Component | Classification | [%] | [%] | [%] | [μm] | [—] | [MPa] | [MPa · degrees] | cracking |
| 1 | A | Example | 100 | 0 | 0 | 6.7 | 1.6 | 1957 | 131076 | Absent |
| 2 | B | Example | 98 | 0 | 2 | 6.9 | 1.6 | 1487 | 131728 | Absent |
| 3 | C | Example | 100 | 0 | 0 | 4.3 | 1.6 | 1867 | 130753 | Absent |
| 4 | D | Example | 99 | 0 | 1 | 6.8 | 1.9 | 1390 | 132013 | Absent |
| 5 | E | Example | 97 | 86 | 3 | 4.1 | 1.8 | 1495 | 134098 | Absent |
| 6 | F | Example | 100 | 0 | 0 | 6.9 | 1.6 | 1739 | 130522 | Absent |
| 7 | G | Example | 97 | 0 | 3 | 6.6 | 1.9 | 1704 | 130521 | Absent |
| 8 | H | Example | 98 | 0 | 2 | 6.7 | 1.8 | 1788 | 131652 | Absent |
| 9 | I | Example | 99 | 0 | 1 | 4.1 | 1.7 | 1337 | 130490 | Absent |
| 10 | J | Example | 97 | 0 | 3 | 4.2 | 1.6 | 1840 | 131164 | Absent |
| 11 | K | Example | 98 | 0 | 2 | 7.0 | 1.6 | 1732 | 130528 | Absent |
| 12 | L | Example | 99 | 0 | 1 | 5.0 | 1.9 | 1582 | 131166 | Absent |
| 13 | M | Example | 99 | 0 | 1 | 4.3 | 1.7 | 1619 | 131969 | Absent |
| 14 | N | Example | 100 | 0 | 0 | 4.1 | 1.6 | 1715 | 130651 | Absent |
| 15 | O | Example | 100 | 0 | 0 | 6.1 | 2.0 | 1636 | 130839 | Absent |
| 16 | P | Example | 97 | 0 | 3 | 7.0 | 1.6 | 1545 | 131504 | Absent |
| 17 | Q | Example | 97 | 0 | 3 | 5.3 | 1.8 | 1621 | 132027 | Absent |
| 18 | R | Example | 100 | 0 | 0 | 6.9 | 1.6 | 1738 | 131088 | Absent |
| 19 | S | Example | 100 | 0 | 0 | 5.2 | 1.8 | 1604 | 131918 | Absent |
| 20 | T | Example | 97 | 0 | 3 | 4.2 | 2.0 | 1693 | 131416 | Absent |
| 21 | U | Example | 100 | 93 | 0 | 5.0 | 1.6 | 1489 | 134028 | Absent |
| 22 | V | Example | 100 | 0 | 0 | 4.2 | 1.7 | 1617 | 132062 | Absent |
| 23 | W | Example | 97 | 0 | 3 | 7.0 | 1.8 | 1483 | 131732 | Absent |
| 24 | X | Example | 100 | 0 | 0 | 6.1 | 1.6 | 1970 | 132012 | Absent |
| 25 | Y | Example | 98 | 23 | 2 | 6.4 | 1.7 | 1559 | 131948 | Absent |
| 26 | Z | Example | 97 | 0 | 3 | 5.3 | 1.7 | 1440 | 131679 | Absent |
| 27 | AA | Example | 99 | 0 | 1 | 6.8 | 1.6 | 1454 | 132092 | Absent |
| 28 | AB | Example | 100 | 0 | 0 | 4.9 | 1.6 | 1583 | 132075 | Absent |
| 29 | AC | Example | 100 | 0 | 0 | 5.8 | 1.7 | 1431 | 132097 | Absent |
| 30 | AD | Example | 98 | 0 | 2 | 4.2 | 1.6 | 1711 | 132075 | Absent |
| 31 | AE | Comparative | 100 | 0 | 0 | 6.9 | 1.9 | 1288 | 131949 | Absent |
| | | Example | | | | | | | | |
| 32 | AF | Comparative | 97 | 0 | 3 | 6.8 | 1.7 | 1866 | 102100 | Absent |
| | | Example | | | | | | | | |
| 33 | AG | Comparative | 97 | 0 | 3 | 6.0 | 1.6 | 1303 | 131400 | Absent |
| | | Example | | | | | | | | |
| 34 | AH | Comparative | 98 | 0 | 2 | 5.0 | 1.7 | 1368 | 131973 | Present |
| | | Example | | | | | | | | |
| 35 | AI | Comparative | 91 | 57 | 9 | 9.0 | 1.8 | 1279 | 128291 | Present |
| | | Example | | | | | | | | |
| 36 | AJ | Comparative | 100 | 0 | 0 | 4.2 | 1.6 | 1571 | 131620 | Not |
| | | Example | | | | | | | | evaluable |

TABLE 4B

| | | | t/4 position microstructure | | | | | | | |
|---|---|---|---|---|---|---|---|---|---|---|
| | | | | | | | Grain | | | |
| | | | | | | | boundary | | | |
| | | | | | | | segregation | | | |
| | | | | | | | degree of | | | |
| | | | | | | | Mn (grain | | | |
| | | | | Tempered | | Prior | boundary | Properties | | |
| | | | Martensite | martensite | Remainder | austenite | concentration/ | | | Presence or |
| | | | volume | volume | volume | grain | base metal | | TS × bending | absence |
| | | | percentage | percentage | percentage | size | concentration) | TS | angle | of LME |
| No. | Component | Classification | [%] | [%] | [%] | [μm] | [—] | [MPa] | [MPa · degrees] | cracking |
| 37 | AK | Comparative | 100 | 0 | 0 | 7.0 | 1.6 | 1792 | 130355 | Present |
| | | Example | | | | | | | | |
| 38 | AL | Comparative | Subsequent tests were canceled due to slab cracking. | | | | | | | |
| | | Example | | | | | | | | |
| 39 | AM | Comparative | 81 | 0 | 19 | 8.1 | 1.8 | 1270 | 101994 | Present |
| | | Example | | | | | | | | |
| 40 | AN | Comparative | 99 | 0 | 1 | 5.0 | 1.6 | 1368 | 120763 | Absent |
| | | Example | | | | | | | | |
| 41 | AO | Comparative | 89 | 0 | 11 | 9.4 | 1.9 | 1307 | 121427 | Present |
| | | Example | | | | | | | | |
| 42 | AP | Comparative | Subsequent tests were canceled due to slab cracking. | | | | | | | |
| | | Example | | | | | | | | |
| 43 | A | Example | 99 | 0 | 1 | 5.1 | 1.6 | 1781 | 131390 | Absent |
| 44 | B | Example | 99 | 0 | 1 | 5.2 | 1.6 | 1624 | 130791 | Absent |
| 45 | C | Example | 99 | 0 | 1 | 4.2 | 1.6 | 1802 | 131711 | Absent |
| 46 | D | Example | 99 | 0 | 1 | 6.0 | 1.6 | 1542 | 130807 | Absent |
| 47 | E | Example | 99 | 0 | 1 | 5.6 | 2.0 | 1396 | 132025 | Absent |
| 48 | F | Example | 99 | 0 | 1 | 4.8 | 1.6 | 1699 | 131963 | Absent |
| 49 | G | Example | 99 | 0 | 1 | 5.0 | 2.0 | 1881 | 131866 | Absent |
| 50 | H | Example | 100 | 0 | 0 | 4.0 | 1.8 | 1842 | 131006 | Absent |
| 51 | I | Example | 99 | 0 | 1 | 4.1 | 1.9 | 1346 | 130925 | Absent |
| 52 | J | Example | 100 | 0 | 0 | 6.4 | 1.6 | 1947 | 132075 | Absent |
| 53 | K | Example | 100 | 0 | 0 | 5.6 | 1.6 | 1760 | 132068 | Absent |
| 54 | L | Example | 99 | 0 | 1 | 4.0 | 1.6 | 1446 | 130499 | Absent |
| 55 | M | Example | 100 | 0 | 0 | 4.2 | 1.7 | 1532 | 132099 | Absent |
| 56 | N | Example | 97 | 0 | 3 | 6.9 | 2.0 | 1842 | 130115 | Absent |
| 57 | O | Example | 100 | 0 | 0 | 4.4 | 1.6 | 1641 | 131632 | Absent |
| 58 | P | Example | 97 | 0 | 3 | 4.0 | 1.7 | 1433 | 130130 | Absent |
| 59 | Q | Example | 98 | 0 | 2 | 6.9 | 1.6 | 1691 | 132093 | Absent |
| 60 | R | Example | 98 | 0 | 2 | 4.2 | 1.6 | 1668 | 132074 | Absent |
| 61 | S | Example | 98 | 0 | 2 | 6.9 | 1.7 | 1528 | 131861 | Absent |
| 62 | V | Example | 97 | 0 | 3 | 7.0 | 1.7 | 1612 | 132099 | Absent |
| 63 | W | Comparative | 100 | 0 | 0 | 5.6 | 3.0 | 1450 | 102023 | Absent |
| | | Example | | | | | | | | |
| 64 | Y | Comparative | 99 | 0 | 1 | 9.2 | 2.0 | 1576 | 127551 | Present |
| | | Example | | | | | | | | |
| 65 | AA | Comparative | 100 | 5 | 0 | 8.1 | 1.6 | 1334 | 125051 | Present |
| | | Example | | | | | | | | |
| 66 | AD | Comparative | 100 | 0 | 0 | 8.3 | 1.9 | 1750 | 121198 | Present |
| | | Example | | | | | | | | |
| 67 | C | Example | 99 | 0 | 1 | 7.0 | 2.0 | 1739 | 132059 | Absent |
| 68 | E | Comparative | 79 | 0 | 21 | 5.6 | 1.7 | 1213 | 132100 | Absent |
| | | Example | | | | | | | | |
| 69 | G | Comparative | 92 | 0 | 8 | 6.2 | 1.8 | 1308 | 132096 | Absent |
| | | Example | | | | | | | | |
| 70 | Q | Comparative | 100 | 100 | 0 | 5.5 | 1.7 | 1201 | 132027 | Absent |
| | | Example | | | | | | | | |
| 71 | J | Comparative | 88 | 0 | 12 | 4.3 | 1.6 | 1297 | 132041 | Absent |
| | | Example | | | | | | | | |
| 72 | L | Comparative | 92 | 0 | 8 | 5.2 | 1.6 | 1302 | 131724 | Absent |
| | | Example | | | | | | | | |
| 73 | M | Example | 100 | 0 | 0 | 6.9 | 2.0 | 1523 | 130299 | Absent |
| 74 | N | Comparative | 93 | 0 | 7 | 6.9 | 1.9 | 1302 | 130115 | Absent |
| | | Example | | | | | | | | |
| 75 | O | Comparative | 94 | 0 | 6 | 4.4 | 1.7 | 1291 | 130263 | Absent |
| | | Example | | | | | | | | |
| 76 | P | Comparative | 97 | 0 | 3 | 4.2 | 1.6 | 1533 | 129130 | Absent |
| | | Example | | | | | | | | |

As shown in Tables 1A to 4B, the cold-rolled steel sheet of the present invention has a chemical composition, a microstructure, and a grain boundary segregation degree of Mn within the ranges of the invention, and has a high tensile strength, excellent bendability, and superior LME resistance.

Contrary to this, in the comparative examples, one or more of the chemical composition, the microstructure, and the grain boundary segregation degree of Mn were outside the ranges of the invention, and one or more of the tensile strength, bendability, and LME resistance were inferior.

### Example 2

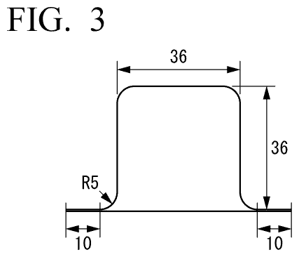

A part of the cold-rolled steel sheets obtained in Example 1 was processed to obtain a hat-shaped member. Then, as a back sheet, a commercially available hot-dip galvannealed steel sheet was used, and the back sheet was joined to a flange portion by spot welding to manufacture a steel member having a closed cross-sectional structure shown in FIG. 3. Welding conditions were the same as in Example 1.

For the structure at the t/4 position of a center portion of a top sheet portion, which is a non-processed portion of the obtained steel member, the volume percentage of each phase, the prior austenite grain size, and the grain boundary segregation degree of Mn were measured by the above-described methods. As a result, although not shown in the tables, all of the steel sheets were equivalent to the cold-rolled steel sheet.

In addition, test pieces were collected from the non-processed portion of the steel member, that is, the top sheet portion, and the tensile strength and bendability were evaluated in the same manner as in Example 1.

In addition, a cross section of the steel sheet including a center of a nugget was polished from a welded part, and the presence or absence of LME cracking was evaluated in the same manner as in Example 1.

In this case, as in Example 1, the presence or absence of cracks was evaluated at three locations, that is, the inner crack 3a, the outer crack 3b, and the outer crack 3c of the steel sheet portion not in direct contact with the electrode was evaluated. In a case where a crack having a length of more than 0.2 mm was observed at even one of the three locations, the presence of LME cracking was determined. The results are shown in Table 5.

TABLE 5

Properties

| | | | | Presence or |
|---|---|---|---|---|
| Steel | Steel | | TS × bending | absence of |
| member | sheet | TS | angle | LME |
| No. | No. | [MPa] | [MPa · degrees] | cracking |
| 1 | 5 | 1499 | 134111 | Absent |
| 2 | 64 | 1566 | 125234 | Present |
| 3 | 67 | 1730 | 130445 | Absent |

As shown in Table 5, in the non-processed portion, the same properties as those of the cold-rolled steel sheet were obtained.

### INDUSTRIAL APPLICABILITY

According to the present invention, it is possible to provide a cold-rolled steel sheet having a high tensile strength, excellent bendability, and superior LME resistance. This cold-rolled steel sheet has a high tensile strength, excellent bendability, and superior LME resistance, at least in a non-processed portion, even after being used as a steel member. Therefore, present invention is capable of contributing to solving the global environmental issue by reducing the vehicle body weights of vehicles and significantly contributes to industrial development, and the like.

### REFERENCE SIGNS LIST

1 Joint
1a Steel sheet
1b Steel sheet
1c Steel sheet
1d Steel sheet
1e Steel sheet
2 Nugget
3a Inner crack between steel sheets
3b Outer crack at contact portion between steel sheet and spot welding electrode
3c Outer crack in steel sheet portion
4a Electrode
4b Electrode
5 Electrode centerline
6 Vertical line
P Weld force
θ Inclination angle of electrode
t1 First energization time
t2 Second energization time
tc Non-energization period

1. A cold-rolled steel sheet comprising, as a chemical composition, by mass %:
C: 0.180% or more and 0.400% or less;
Si: 0.050% or more and 1.000% or less;
Mn: 2.00% or more and 4.00% or less;
Al: 0.10% or more and 2.00% or less;
Ti: 0.010% or more and 0.200% or less;
B: 0.0010% or more and 0.0100% or less;
N: 0.0010% or more and 0.0100% or less;
P: 0% or more and 0.0400% or less;
S: 0% or more and 0.0100% or less;
O: 0% or more and 0.0060% or less;
Cr: 0% or more and 0.50% or less;
Ni: 0% or more and 1.00% or less;
Cu: 0% or more and 1.00% or less;
Mo: 0% or more and 0.500% or less;
Nb: 0% or more and 0.200% or less;
V: 0% or more and 0.500% or less;
W: 0% or more and 0.100% or less;
Ta: 0% or more and 0.100% or less;
Sn: 0% or more and 0.050% or less;
Co: 0% or more and 0.500% or less;
Sb: 0% or more and 0.050% or less;
As: 0% or more and 0.050% or less;
Mg: 0% or more and 0.050% or less;
Ca: 0% or more and 0.040% or less;
REM: 0% or more and 0.050% or less;
Bi: 0% or more and 0.050% or less;
Zr: 0% or more and 0.050% or less;
Sr: 0% or more and 0.050% or less; and
a remainder including Fe and impurities,
wherein, when a sheet thickness in units of mm is denoted by t, and a range from a t/8 position to a 3t/8 position in a sheet thickness direction from a surface of the cold-rolled steel sheet is denoted by a t/4 position,
at the t/4 position,
a microstructure contains, by volume percentage, martensite: 95% or more, in which a volume percentage of tempered martensite is 95% or less,
a prior austenite grain size is 7.0 μm or less, and
a grain boundary segregation degree of Mn is 2.0 or less.

2. The cold-rolled steel sheet according to claim 1,
wherein the cold-rolled steel sheet has a hot-dip galvanized layer on the surface.

3. The cold-rolled steel sheet according to claim 2,
wherein the hot-dip galvanized layer is a hot-dip galvannealed layer.

4. A steel member comprising:
a processed portion; and
a non-processed portion,
wherein at least the non-processed portion contains, as a chemical composition, by mass %,
C: 0.180% or more and 0.400% or less,
Si: 0.050% or more and 1.000% or less,
Mn: 2.00% or more and 4.00% or less,
Al: 0.10% or more and 2.00% or less,
Ti: 0.010% or more and 0.200% or less,
B: 0.0010% or more and 0.0100% or less,
N: 0.0010% or more and 0.0100% or less,
P: 0% or more and 0.0400% or less,
S: 0% or more and 0.0100% or less,
O: 0% or more and 0.0060% or less,
Cr: 0% or more and 0.50% or less,
Ni: 0% or more and 1.00% or less,
Cu: 0% or more and 1.00% or less,
Mo: 0% or more and 0.500% or less,
Nb: 0% or more and 0.200% or less,
V: 0% or more and 0.500% or less,
W: 0% or more and 0.100% or less,
Ta: 0% or more and 0.100% or less,
Sn: 0% or more and 0.050% or less,
Co: 0% or more and 0.500% or less,
Sb: 0% or more and 0.050% or less,
As: 0% or more and 0.050% or less,
Mg: 0% or more and 0.050% or less,
Ca: 0% or more and 0.040% or less,
REM: 0% or more and 0.050% or less,
Bi: 0% or more and 0.050% or less,
Zr: 0% or more and 0.050% or less,
Sr: 0% or more and 0.050% or less, and
a remainder including Fe and impurities,
when a thickness in units of mm is denoted by t, and a range from a t/8 position to a 3t/8 position in a thickness direction from a surface of the steel member is denoted by a t/4 position,
at the t/4 position,
a microstructure contains, by volume percentage, martensite: 95% or more, in which a volume percentage of tempered martensite is 95% or less,
a prior austenite grain size is 7.0 μm or less, and
a grain boundary segregation degree of Mn is 2.0 or less.

5. The steel member according to claim 4,
wherein the steel member has a hot-dip galvanized layer on the surface.

6. The steel member according to claim 5,
wherein the hot-dip galvanized layer is a hot-dip galvannealed layer.
